(19) United States
(12) Patent Application Publication
(10) Pub. No.: US 2018/0249156 A1
(43) Pub. Date: Aug. 30, 2018

(54) METHOD FOR PROCESSING IMAGE BASED ON JOINT INTER-INTRA PREDICTION MODE AND APPARATUS THEREFOR

(71) Applicant: LG Electronics Inc., Seoul (KR)

(72) Inventors: Jin HEO, Seoul (KR); Seungwook PARK, Seoul (KR); Eunyong SON, Seoul (KR); Naeri PARK, Seoul (US)

(21) Appl. No.: 15/758,275

(22) PCT Filed: Sep. 2, 2016
(86) PCT No.: PCT/KR2016/009871

§ 371 Date: Mar. 7, 2018

Related U.S. Application Data
(60) Provisional application No. 62/217,011, filed on Sep. 10, 2015.

(51) Int. Cl. H04N 19/105; H04N 19/147; H04N 19/176

(52) U.S. Cl. CPC H04N 19/105; H04N 19/139; H04N 19/176; H04N 19/147

(57) ABSTRACT

The present invention provides a method for processing an image based on a Joint inter-intra prediction mode and an apparatus for the same. Particularly, the method may include deriving a prediction mode of a current block; generating an inter-prediction block of the current block and an intra-prediction block of the current block, when the prediction mode of the current block is a Joint inter-intra prediction mode; and generating a joint inter-intra prediction block by combining the inter-prediction block and the intra-prediction block.

### CROSS-REFERENCE TO RELATED APPLICATIONS

This application is the National Stage filing under 35 U.S.C. 371 of International Application No. PCT/KR2016/009871, filed on Sep. 2, 2016, which claims the benefit of U.S. Provisional Applications No. 62/217,011, filed on Sep. 10, 2015, the contents of which are all hereby incorporated by reference herein in their entirety.

### TECHNICAL FIELD

The present invention relates to an image processing method, more particularly, to a method for encoding/decoding an image based in a joint inter-intra prediction mode and an apparatus supporting the same.

### BACKGROUND ART

Compression encoding means a series of signal processing techniques for transmitting digitized information through a communication line or techniques for storing the information in a form that is proper for a storage medium. The media including a picture, an image, an audio, and the like may be the target for the compression encoding, and particularly, the technique of performing the compression encoding targeted to the picture is referred to as a video image compression.

Next generation video content is supposed to have the characteristics of high spatial resolution, a high frame rate and high dimensionality of scene representation. In order to process such content, a drastic increase of memory storage, a memory access rate and processing power will result.

Accordingly, it is required to design a coding tool for efficiently processing a next generation video content.

### DISCLOSURE

### Technical Problem

In the existing prediction method, an encoding is performed by selecting one of the methods among a prediction method between images (inter-prediction method) or a prediction method within an image (intra-prediction method). The prediction block determined through the inter-prediction method may be optimal for the whole block to encode, but may not be optimal as a pixel in a block.

On the other hand, the intra-prediction method generates each pixel in a prediction block by using neighboring reconstructed pixels and accordingly, predicts accurately in a pixel unit more than the inter-prediction. However, there is a problem that an accuracy of prediction becomes degraded as a distance increases between a reconstructed pixel and a prediction pixel.

An object of the present invention is to provide a method for encoding/decoding a still image or a video image based on Joint inter-intra prediction mode to solve such a problem.

In addition, an object of the present invention is to provide different Joint inter-intra prediction methods depending on a transmission of the intra-prediction mode.

In addition, an object of the present invention is to provide a method for generating a Joint inter-intra prediction block by providing a weight on an inter-prediction block and an intra-prediction block.

Technical objects to be achieved by the present invention are not limited to the aforementioned objects, and a person having ordinary skill in the art to which the present invention pertains may evidently understand other technological objects from the following description.

### Technical Solution

According to an aspect of the present invention, a method for processing an image by combining an inter-prediction and an intra-prediction may include deriving a prediction mode of a current block; generating an inter-prediction block of the current block and an intra-prediction block of the current block, when the prediction mode of the current block is a Joint inter-intra prediction mode; and generating a joint inter-intra prediction block by combining the inter-prediction block and the intra-prediction block.

According to another aspect of the present invention, an apparatus for processing an image by combining an inter-prediction and an intra-prediction may include a prediction mode derivation unit for deriving a prediction mode of a current block; an inter-prediction block generation unit for generating an inter-prediction block by performing an inter-prediction for the current block; an intra-prediction block generation unit for generating an intra-prediction block by performing an intra-prediction for the current block; and a joint inter-intra prediction block generation unit for generating a joint inter-intra prediction block by combining the inter-prediction block and the intra-prediction block.

Preferably, when intra-prediction mode information of the current block is not transmitted, the intra-prediction block may be generated by an intra-prediction by using a reference block neighboring a block corresponding to the current block in a reference picture.

Preferably, the intra-prediction mode used in the intra-prediction may be determined to be a mode that minimizes a Rate-Distortion Cost of the intra-prediction block.

Preferably, the Rate-Distortion Cost may be derived from a summation of Distortion and Rate, a value of the Distortion may be calculated by Sum of Square Difference (SSD) of the inter-prediction block and the intra-prediction block, and a value of the Rate may be calculated by considering a bit required to encode residual information that subtracts the intra-prediction block from the inter-prediction block.

Preferably, when intra-prediction mode information of the current block is transmitted, the intra-prediction block may be generated by an intra-prediction by using the intra-prediction mode.

Preferably, the joint inter-intra prediction block may be generated by combining the inter-prediction block to which a first weight is applied and the intra-prediction block to which a second weight is applied.

Preferably, a ratio of the first weight and the second weight may be determined according to a ratio of Sum of Square Difference (SSD) value of the current block and the inter-prediction block to SSD value between the current block and the intra-prediction block.

Preferably, the first weight and the second weight may be applied in a unit of block or a unit of pixel to the inter-prediction block and the intra-prediction block.

Preferably, the second weight decreases and the first weight increases as a distance between a reference pixel used in the intra-prediction and a prediction pixel of the current block increases.

Preferably, a ratio of the first weight and the second weight may be changed according to a vertical coordinate of a prediction pixel of the current block, when the intra-prediction mode is a vertical mode.

Preferably, a ratio of the first weight and the second weight may be changed according to a horizontal coordinate of a prediction pixel of the current block, when the intra-prediction mode is a horizontal mode.

Preferably, the first weight and the second weight may be determined from a weight table which is predetermined according to the inter-prediction mode and/or the intra prediction mode.

Preferably, the method may further include receiving a table index for specifying the first weight and the second weight, and the first weight and the second weight may be determined from a predetermined table by the table index.

### Technical Effects

According to an embodiment of the present invention, an image is processed based on the Joint inter-intra prediction mode, an optimal block and an optimal pixel are predicted, and an accuracy of prediction may be improved.

In addition, according to an embodiment of the present invention, when an intra-prediction mode is not transmitted, a decoder determines an intra-prediction mode and performs a Joint inter-intra prediction, and accordingly, encoding rate may be improved.

In addition, according to an embodiment of the present invention, a weight is provided to an inter-prediction block and an intra-prediction block and a distance between a reference pixel and a prediction pixel is reflected on the weight, and accordingly, an accuracy of prediction may be improved.

The technical effects of the present invention are not limited to the technical effects described above, and other technical effects not mentioned herein may be understood by those skilled in the art from the description below.

### DESCRIPTION OF DRAWINGS

The accompanying drawings, which are included herein as a part of the description for helping understanding of the present invention, provide embodiments of the present invention and describe the technical features of the present invention with the description below.

FIG. 1 is an embodiment to which the present invention is applied, and shows a schematic block diagram of an encoder in which the encoding of a still image or moving image signal is performed.

FIG. 2 is an embodiment to which the present invention is applied, and shows a schematic block diagram of a decoder in which the encoding of a still image or moving image signal is performed.

FIG. 3 is a diagram for illustrating the split structure of a coding unit to which the present invention may be applied.

FIG. 4 is a diagram for illustrating a prediction unit to which the present invention may be applied.

FIG. 5 is an embodiment to which the present invention is applied and is a diagram illustrating an intra-prediction method.

FIG. 6 illustrates prediction directions according to intra-prediction modes.

FIG. 7 is a diagram illustrating a direction of an inter-prediction as an embodiment to which the present invention may be applied.

FIG. 8 illustrates an integer and fractional sample position for 1/4 sample interpolation as an embodiment to which the present invention may be applied.

FIG. 9 illustrates a position of spatial candidate as an embodiment to which the present invention may be applied.

FIG. 10 is a diagram illustrating an inter-prediction method as an embodiment to which the present invention is applied.

FIG. 11 is a diagram illustrating a motion compensation procedure as an embodiment to which the present invention is applied.

FIG. 12 illustrates a schematic block diagram of an encoder including a Joint inter-intra prediction unit as an embodiment to which the present invention is applied.

FIG. 13 illustrates a schematic block diagram of a decoder including a Joint inter-intra prediction unit as an embodiment to which the present invention is applied.

FIG. 14 is a diagram illustrating a method of generating an inter-prediction block according to an embodiment of the present invention.

FIG. 15 is a diagram illustrating a method of generating an intra-prediction block according to an embodiment of the present invention.

FIG. 16 is a diagram illustrating an image processing method based on a joint inter-intra prediction mode according to an embodiment of the present invention.

FIG. 17 is a diagram illustrating a method for generating an intra-prediction block according to an embodiment of the present invention.

FIG. 18 is a diagram illustrating an image processing method based on a Joint inter-intra prediction mode according to an embodiment of the present invention.

FIG. 19 is a diagram illustrating a method for determining a weight according to an embodiment of the present invention.

FIG. 20 is a diagram illustrating an image processing method based on a Joint inter-intra prediction mode according to an embodiment of the present invention.

FIG. 21 is a diagram illustrating a Joint inter-intra prediction unit according to an embodiment of the present invention.

### MODE FOR INVENTION

Hereinafter, preferred embodiments of the present invention will be described by reference to the accompanying drawings. The description that will be described below with the accompanying drawings is to describe exemplary embodiments of the present invention, and is not intended to describe the only embodiment in which the present invention may be implemented. The description below includes particular details in order to provide perfect understanding of the present invention. However, it is understood that the present invention may be embodied without the particular details to those skilled in the art.

In some cases, in order to prevent the technical concept of the present invention from being unclear, structures or devices which are publicly known may be omitted, or may be depicted as a block diagram centering on the core functions of the structures or the devices.

Further, although general terms widely used currently are selected as the terms in the present invention as much as possible, a term that is arbitrarily selected by the applicant is used in a specific case. Since the meaning of the term will be clearly described in the corresponding part of the description in such a case, it is understood that the present invention will not be simply interpreted by the terms only used in the description of the present invention, but the meaning of the terms should be figured out.

Specific terminologies used in the description below may be provided to help the understanding of the present invention. Furthermore, the specific terminology may be modified into other forms within the scope of the technical concept of the present invention. For example, a signal, data, a sample, a picture, a frame, a block, etc may be properly replaced and interpreted in each coding process.

Hereinafter, in this specification, a “processing unit” means a unit by which an encoding/decoding processing process, such as prediction, transform and/or quantization, is performed. Hereinafter, for convenience of description, a processing unit may also be called a “processing block” or “block.”

A processing unit may be construed as a meaning including a unit for a luma component and a unit for a chroma component. For example, a processing unit may correspond to a coding tree unit (CTU), a coding unit (CU), a prediction unit (PU) or a transform unit (TU).

Furthermore, a processing unit may be construed as a unit for a luma component or a unit for a chroma component. For example, a processing unit may correspond to a coding tree block (CTB), coding block (CB), prediction block (PB) or transform block (TB) for a luma component. Alternatively, a processing unit may correspond to a coding tree block (CTB), coding block (CB), prediction block (PB) or transform block (TB) for a chroma component. Furthermore, the present invention is not limited thereto, and a processing unit may be construed as a meaning including a unit for a luma component and a unit for a chroma component.

Furthermore, a processing unit is not essentially limited to a block of a square, but may have a polygon form having three or more vertexes.

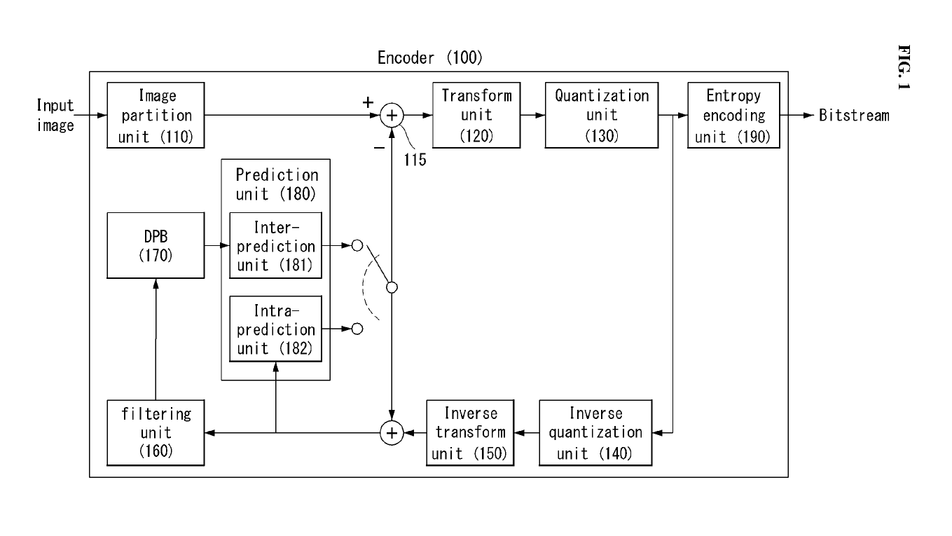

FIG. 1 is an embodiment to which the present invention is applied, and shows a schematic block diagram of an encoder in which the encoding of a still image or moving image signal is performed.

Referring to FIG. 1, an encoder 100 may include a picture split unit 110, a subtraction unit 115, a transform unit 120, a quantization unit 130, a dequantization unit 140, an inverse transform unit 150, a filtering unit 160, a decoded picture buffer (DPB) 170, a prediction unit 180 and an entropy encoding unit 190. Furthermore, the prediction unit 180 may include an inter-prediction unit 181 and an intra-prediction unit 182.

The video split unit 110 splits an input video signal (or picture or frame), input to the encoder 100, into one or more processing units.

The subtractor 115 generates a residual signal (or residual block) by subtracting a prediction signal (or prediction block), output by the prediction unit 180 (i.e., inter-prediction unit 181 or intra-prediction unit 182), from the input video signal. The generated residual signal (or residual block) is transmitted to the transform unit 120.

The transform unit 120 generates transform coefficients by applying a transform scheme (e.g., discrete cosine transform (DCT), discrete sine transform (DST), graph-based transform (GBT) or Karhunen-Loeve transform (KLT)) to the residual signal (or residual block). In this case, the transform unit 120 may generate the transform coefficients by performing transform using a determined transform scheme depending on a prediction mode applied to the residual block and the size of the residual block.

The quantization unit 130 quantizes the transform coefficient and transmits it to the entropy encoding unit 190, and the entropy encoding unit 190 performs an entropy coding operation of the quantized signal and outputs it as a bit stream.

Meanwhile, the quantized signal that is outputted from the quantization unit 130 may be used for generating a prediction signal. For example, by applying dequantization and inverse transformation to the quantized signal through the dequantization unit 140 and the inverse transform unit 150, the residual signal may be reconstructed. By adding the reconstructed residual signal to the prediction signal that is outputted from the inter-prediction unit 181 or the intra-prediction unit 182, a reconstructed signal may be generated.

Meanwhile, during such a compression process, adjacent blocks are quantized by different quantization parameters from each other, and accordingly, an artifact in which block boundaries are shown may occur. Such a phenomenon is referred to blocking artifact, which is one of the important factors for evaluating image quality. In order to decrease such an artifact, a filtering process may be performed. Through such a filtering process, the blocking artifact is removed and the error for the current picture is decreased at the same time, thereby the image quality being improved.

The filtering unit 160 applies filtering to the reconstructed signal, and outputs it through a play-back device or transmits it to the decoded picture buffer 170. The filtered signal transmitted to the decoded picture buffer 170 may be used as a reference picture in the inter-prediction unit 181. As such, by using the filtered picture as a reference picture in an inter-prediction mode, the encoding rate as well as the image quality may be improved.

The decoded picture buffer 170 may store the filtered picture in order to use it as a reference picture in the inter-prediction unit 181.

The inter-prediction unit 181 performs a temporal prediction and/or a spatial prediction by referencing the reconstructed picture in order to remove a temporal redundancy and/or a spatial redundancy.

In this case, since the reference picture used for performing a prediction is a transformed signal that goes through the quantization or the dequantization by a unit of block when being encoded/decoded previously, there may exist blocking artifact or ringing artifact.

Accordingly, in order to solve the performance degradation owing to the discontinuity of such a signal or the quantization, by applying a low pass filter to the inter-prediction unit 181, the signals between pixels may be interpolated by a unit of sub-pixel. Herein, the sub-pixel means a virtual pixel that is generated by applying an interpolation filter, and an integer pixel means an actual pixel that is existed in the reconstructed picture. As a method of interpolation, a linear interpolation, a bi-linear interpolation, a wiener filter, and the like may be applied.

The interpolation filter may be applied to the reconstructed picture, and may improve the accuracy of prediction. For example, the inter-prediction unit 181 may perform prediction by generating an interpolation pixel by applying the interpolation filter to the integer pixel, and by using the interpolated block that includes interpolated pixels as a prediction block.

The intra-prediction unit 182 predicts the current block by referring to the samples adjacent the block that is to be encoded currently. The intra-prediction unit 182 may perform the following procedure in order to perform the intra-prediction. First, the intra-prediction unit 182 may prepare a reference sample that is required for generating a prediction signal. Furthermore, the intra-prediction unit 182 may generate a prediction signal by using the reference sample prepared. Thereafter, the intra-prediction unit 182 may encode the prediction mode. In this case, the reference sample may be prepared through reference sample padding and/or reference sample filtering. Since the reference sample goes through the prediction and the reconstruction process, there may be a quantization error. Accordingly, in order to decrease such an error, the reference sample filtering process may be performed for each prediction mode that is used for the intra-prediction.

The prediction signal (or prediction block) generated through the inter-prediction unit 181 or the intra-prediction unit 182 may be used to generate a reconstructed signal (or reconstructed block) or may be used to generate a residual signal (or residual block).

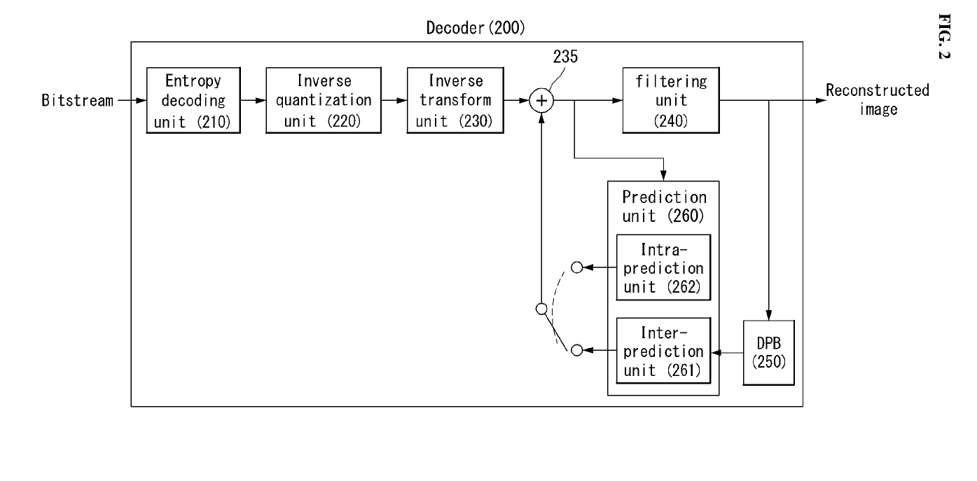

FIG. 2 is an embodiment to which the present invention is applied, and shows a schematic block diagram of a decoder in which the encoding of a still image or moving image signal is performed.

Referring to FIG. 2, a decoder 200 may include an entropy decoding unit 210, a dequantization unit 220, an inverse transform unit 230, an addition unit 235, a filtering unit 240, a decoded picture buffer (DPB) 250 and a prediction unit 260. Furthermore, the prediction unit 260 may include an inter-prediction unit 261 and an intra-prediction unit 262.

Furthermore, the reconstructed video signal outputted through the decoder 200 may be played through a play-back device.

The decoder 200 receives the signal (i.e., bit stream) outputted from the encoder 100 shown in FIG. 1, and the entropy decoding unit 210 performs an entropy decoding operation of the received signal.

The dequantization unit 220 acquires a transform coefficient from the entropy-decoded signal using quantization step size information.

The inverse transform unit 230 obtains a residual signal (or residual block) by inversely transforming transform coefficients using an inverse transform scheme.

The adder 235 adds the obtained residual signal (or residual block) to the prediction signal (or prediction block) output by the prediction unit 260 (i.e., inter-prediction unit 261 or intra-prediction unit 262), thereby generating a reconstructed signal (or reconstructed block).

The filtering unit 240 applies filtering to the reconstructed signal (or reconstructed block) and outputs it to a playback device or transmits it to the decoding picture buffer unit 250. The filtered signal transmitted to the decoding picture buffer unit 250 may be used as a reference picture in the inter-prediction unit 261.

In this specification, the embodiments described in the filtering unit 160, the inter-prediction unit 181 and the intra-prediction unit 182 of the encoder 100 may also be applied to the filtering unit 240, the inter-prediction unit 261 and the intra-prediction unit 262 of the decoder, respectively, in the same way.

Processing Unit Split Structure

In general, the block-based image compression method is used in a technique (e.g., HEVC) for compressing a still image or a moving image. A block-based image compression method is a method of processing a video by splitting the video into specific block units, and may decrease the capacity of memory and a computational load.

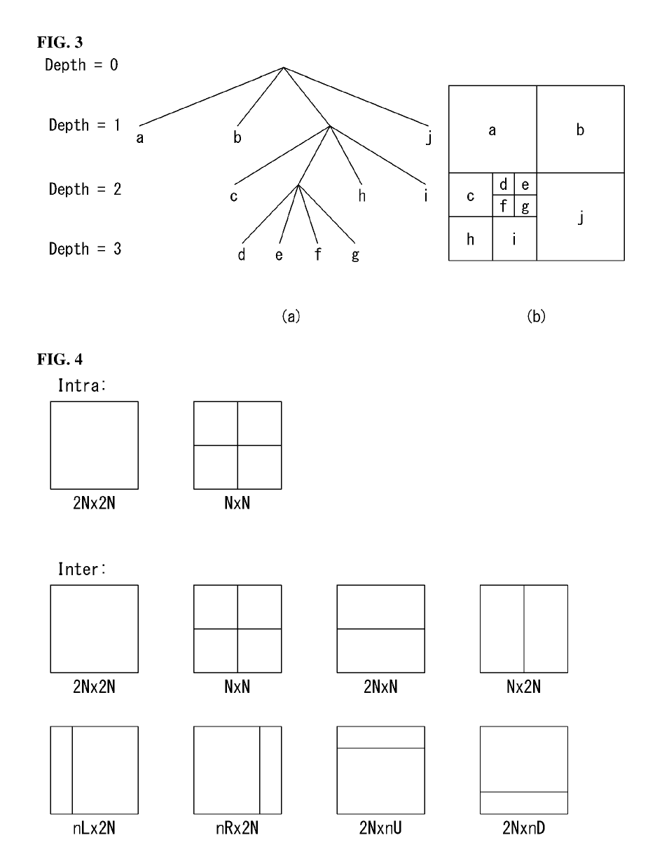

FIG. 3 is a diagram for illustrating the split structure of a coding unit that may be applied to the present invention.

The encoder splits a single image (or picture) in a coding tree unit (CTU) of a rectangle form, and sequentially encodes a CTU one by one according to raster scan order.

In HEVC, the size of a CTU may be determined to be one of 64×64, 32×32 and 16×16. The encoder may select and use the size of CTU according to the resolution of an input video or the characteristics of an input video. A CTU includes a coding tree block (CTB) for a luma component and a CTB for two chroma components corresponding to the luma component.

One CTU may be split in a quad-tree structure. That is, one CTU may be split into four units, each having a half horizontal size and half vertical size while having a square form, thereby being capable of generating a coding unit (CU). The split of the quad-tree structure may be recursively performed. That is, a CU is hierarchically from one CTU in a quad-tree structure.

A CU means a basic unit for a processing process of an input video, for example, coding in which intra/inter prediction is performed. A CU includes a coding block (CB) for a luma component and a CB for two chroma components corresponding to the luma component. In HEVC, the size of a CU may be determined to be one of 64×64, 32×32, 16>16 and 8×8.

Referring to FIG. 3, a root node of a quad-tree is related to a CTU. The quad-tree is split until a leaf node is reached, and the leaf node corresponds to a CU.

This is described in more detail. A CTU corresponds to a root node and has the deepest depth (i.e., depth=0) value. A CTU may not be split depending on the characteristics of an input video. In this case, the CTU corresponds to a CU.

A CTU may be split in a quad-tree form. As a result, lower nodes of a depth 1 (depth=1) are generated. Furthermore, a node (i.e., a leaf node) no longer split from the lower node having the depth of 1 corresponds to a CU. For example, in FIG. 3(b), a CU(a), CU(b) and CU(j) corresponding to nodes a, b and j have been once split from a CTU, and have a depth of 1.

At least one of the nodes having the depth of 1 may be split in a quad-tree form again. As a result, lower nodes of a depth 2 (i.e., depth=2) are generated. Furthermore, a node (i.e., leaf node) no longer split from the lower node having the depth of 2 corresponds to a CU. For example, in FIG. 3(b), a CU(c), CU(h) and CU(i) corresponding to nodes c, h and i have been twice split from the CTU, and have a depth of 2.

Furthermore, at least one of the nodes having the depth of 2 may be split in a quad-tree form again. As a result, lower nodes having a depth of 3 (i.e., depth=3) are generated. Furthermore, a node (i.e., leaf node) no longer split from the lower node having the depth of 3 corresponds to a CU. For example, in FIG. 3(b), a CU(d), CU(e), CU(f) and CU(g) corresponding to nodes d, e, f and g have been split from the CTU three times, and have a depth of 3.

In the encoder, a maximum size or minimum size of a CU may be determined according to the characteristics of a video image (e.g., resolution) or by considering encoding rate. Furthermore, information about the size or information capable of deriving the size may be included in a bit stream. A CU having a maximum size is referred to as the largest coding unit (LCU), and a CU having a minimum size is referred to as the smallest coding unit (SCU).

In addition, a CU having a tree structure may be hierarchically split with predetermined maximum depth information (or maximum level information). Furthermore, each split CU may have depth information. Since the depth information represents the split count and/or degree of a CU, the depth information may include information about the size of a CU.

Since the LCU is split in a quad-tree form, the size of the SCU may be obtained using the size of the LCU and maximum depth information. Alternatively, the size of the LCU may be obtained using the size of the SCU and maximum depth information of a tree.

For a single CU, information (e.g., a split CU flag (split_cu_flag)) indicating whether the corresponding CU is split may be forwarded to the decoder. The split mode is included in all of CUs except the SCU. For example, when the value of the flag indicating whether to split is ‘1’, the corresponding CU is further split into four CUs, and when the value of the flag that represents whether to split is ‘0’, the corresponding CU is not split any more, and the processing process for the corresponding CU may be performed.

As described above, the CU is a basic unit of the coding in which the intra-prediction or the inter-prediction is performed. The HEVC splits the CU in a prediction unit (PU) for coding an input video more effectively.

The PU is a basic unit for generating a prediction block, and even in a single CU, the prediction block may be generated in different way by a unit of a PU. However, the intra-prediction and the inter-prediction are not used together for the PUs that belong to a single CU, and the PUs that belong to a single CU are coded by the same prediction method (i.e., intra-prediction or the inter-prediction).

The PU is not split in the Quad-tree structure, but is split once in a single CU in a predetermined form. This will be described by reference to the drawing below.

FIG. 4 is a diagram for illustrating a prediction unit that may be applied to the present invention.

A PU is differently split depending on whether the intra-prediction mode is used or the inter-prediction mode is used as the coding mode of the CU to which the PU belongs.

FIG. 4(a) illustrates a PU of the case where the intra-prediction mode is used, and FIG. 4(b) illustrates a PU of the case where the inter-prediction mode is used.

Referring to FIG. 4(a), assuming the case where the size of a single CU is 2N×2N (N=4, 8, 16 and 32), a single CU may be split into two types (i.e., 2N×2N or N×N).

In this case, in the case where a single CU is split into the PU of 2N×2N form, it means that only one PU is existed in a single CU.

In contrast, in the case where a single CU is split into the PU of N×N form, a single CU is split into four PUs, and different prediction blocks are generated for each PU unit. However, such a PU split may be performed only in the case where the size of a CB for the luma component of a CU is a minimum size (i.e., if a CU is the SCU).

Referring to FIG. 4(b), assuming that the size of a single CU is 2N×2N (N=4, 8, 16 and 32), a single CU may be split into eight PU types (i.e., 2N×2N, N×N, 2N×N, N×2N, nL×2N, nR×2N, 2N×nU and 2N×nD)

As in intra-prediction, the PU split of N×N form may be performed only in the case where the size of a CB for the luma component of a CU is a minimum size (i.e., if a CU is the SCU).

Inter-prediction supports the PU split of a 2N×N form in the horizontal direction and an N×2N form in the vertical direction.

In addition, the inter-prediction supports the PU split in the form of nL×2N, nR×2N, 2N×nU and 2N×nD, which is asymmetric motion split (AMP). In this case, ‘n’ means ¼ value of 2N. However, the AMP may not be used in the case where a CU to which a PU belongs is a CU of minimum size.

In order to efficiently encode an input video in a single CTU, the optimal split structure of a coding unit (CU), prediction unit (PU) and transform unit (TU) may be determined based on a minimum rate-distortion value through the processing process as follows. For example, as for the optimal CU split process in a 64×64 CTU, the rate-distortion cost may be calculated through the split process from a CU of a 64×64 size to a CU of an 8×8 size. A detailed process is as follows.

1) The optimal split structure of a PU and TU that generates a minimum rate distortion value is determined by performing inter/intra-prediction, transformation/quantization, dequantization/inverse transformation and entropy encoding on a CU of a 64×64 size.

2) The optimal split structure of a PU and TU is determined by splitting a 64×64 CU into four CUs of a 32 ×32 size and generating a minimum rate distortion value for each 32 ×32 CU.

3) The optimal split structure of a PU and TU is determined by further splitting a 32 ×32 CU into four CUs of a 16×16 size and generating a minimum rate distortion value for each 16×16 CU.

4) The optimal split structure of a PU and TU is determined by further splitting a 16×16 CU into four CUs of an 8×8 size and generating a minimum rate distortion value for each 8×8 CU.

5) The optimal split structure of a CU in a 16×16 block is determined by comparing the rate-distortion value of the 16×16 CU obtained in the process of 3) with the addition of the rate-distortion value of the four 8×8 CUs obtained in the process of 4). This process is also performed on the remaining three 16×16 CUs in the same manner.

6) The optimal split structure of a CU in a 32 ×32 block is determined by comparing the rate-distortion value of the 32 ×32 CU obtained in the process of 2) with the addition of the rate-distortion value of the four 16×16 CUs obtained in the process of 5). This process is also performed on the remaining three 32 ×32 CUs in the same manner.

7) Lastly, the optimal split structure of a CU in a 64×64 block is determined by comparing the rate-distortion value of the 64×64 CU obtained in the process of 1) with the addition of the rate-distortion value of the four 32 ×32 CUs obtained in the process of 6).

In an intra-prediction mode, a prediction mode is selected in a PU unit, and prediction and reconstruction are performed on the selected prediction mode in an actual TU unit.

A TU means a basic unit by which actual prediction and reconstruction are performed. A TU includes a transform block (TB) for a luma component and two chroma components corresponding to the luma component.

In the example of FIG. 3, as if one CTU is split in a quad-tree structure to generate a CU, a TU is hierarchically split from one CU to be coded in a quad-tree structure.

A TU is split in the quad-tree structure, and a TU split from a CU may be split into smaller lower TUs. In HEVC, the size of a TU may be determined to be any one of 32×32, 16×16, 8×8 and 4×4.

Referring back to FIG. 3, it is assumed that the root node of the quad-tree is related to a CU. The quad-tree is split until a leaf node is reached, and the leaf node corresponds to a TU.

This is described in more detail. A CU corresponds to a root node and has the deepest depth (i.e., depth=0) value. A CU may not be split depending on the characteristics of an input video. In this case, the CU corresponds to a TU.

A CU may be split in a quad-tree form. As a result, lower nodes, that is, a depth 1 (depth=1), are generated. Furthermore, a node (i.e., leaf node) no longer split from the lower node having the depth of 1 corresponds to a TU. For example, in FIG. 3(b), a TU(a), TU(b) and TU(j) corresponding to the nodes a, b and j have been once split from a CU, and have a depth of 1.

At least one of the nodes having the depth of 1 may be split again in a quad-tree form. As a result, lower nodes, that is, a depth 2 (i.e., depth=2), are generated. Furthermore, a node (i.e., leaf node) no longer split from the lower node having the depth of 2 corresponds to a TU. For example, in FIG. 3(b), a TU(c), TU(h) and TU(i) corresponding to the nodes c, h and i have been split twice from the CU, and have a depth of 2.

Furthermore, at least one of the nodes having the depth of 2 may be split in a quad-tree form again. As a result, lower nodes having a depth of 3 (i.e., depth=3) are generated. Furthermore, a node (i.e., leaf node) no longer split from a lower node having the depth of 3 corresponds to a CU. For example, in FIG. 3(b), a TU(d), TU(e), TU(f), TU(g) corresponding to the nodes d, e, f and g have been split from the CU three times, and have the depth of 3.

A TU having a tree structure may be hierarchically split based on predetermined highest depth information (or highest level information). Furthermore, each split TU may have depth information. The depth information may also include information about the size of the TU because it indicates the number of times and/or degree that the TU has been split.

With respect to one TU, information (e.g., a split TU flag (split_transform_flag)) indicating whether a corresponding TU has been split may be transferred to the decoder. The split information is included in all TUs other than a TU of the least size. For example, if the value of the flag indicating whether a TU has been split is ‘1’, the corresponding TU is split into four TUs. If the value of the flag ‘0’, the corresponding TU is no longer split.

Prediction

In order to reconstruct a current processing unit on which decoding is performed, the decoded part of a current picture including the current processing unit or other pictures may be used.

A picture (slice) using only a current picture for reconstruction, that is, performing only intra-prediction, may be referred to as an intra-picture or I picture (slice). A picture (slice) using the greatest one motion vector and reference index in order to predict each unit may be referred to as a predictive picture or P picture (slice). A picture (slice) using a maximum of two motion vectors and reference indices in order to predict each unit may be referred to as a bi-predictive picture or B picture (slice).

Intra-prediction means a prediction method of deriving a current processing block from a data element (e.g., sample value, etc.) of the same decoded picture (or slice). That is, intra-prediction means a method of predicting a pixel value of the current processing block with reference to reconstructed regions within a current picture.

Hereinafter, intra-prediction is described in more detail.

Intra-Prediction

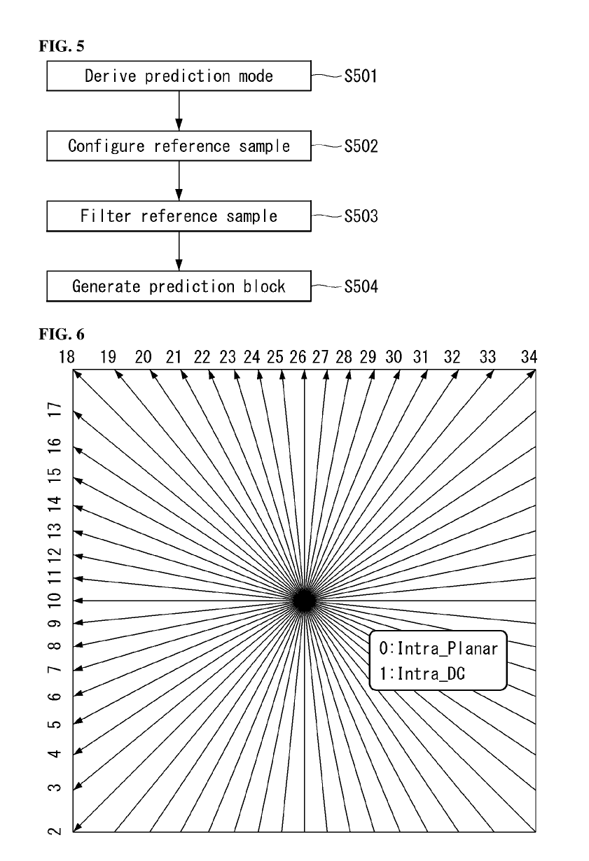

FIG. 5 is an embodiment to which the present invention is applied and is a diagram illustrating an intra-prediction method.

Referring to FIG. 5, the decoder derives an intra-prediction mode of a current processing block (S501).

In intra-prediction, there may be a prediction direction for the location of a reference sample used for prediction depending on a prediction mode. An intra-prediction mode having a prediction direction is referred to as intra-angular prediction mode “Intra_Angular prediction mode.” In contrast, an intra-prediction mode not having a prediction direction includes an intra-planar (INTRA_PLANAR) prediction mode and an intra-DC (INTRA_DC) prediction mode.

Table 1 illustrates intra-prediction modes and associated names, and FIG. 6 illustrates prediction directions according to intra-prediction modes.

TABLE 1

| INTRA | |
|---|---|
| PREDICTION MODE | ASSOCIATED NAMES |
| 0 | INTRA_PLANAR |
| 1 | INTRA_DC |
| 2 . . . 34 | INTRA_ANGULAR2 . . . INTRA_ANGULAR34 |

In intra-prediction, prediction may be on a current processing block based on a derived prediction mode. A reference sample used for prediction and a detailed prediction method are different depending on a prediction mode. Accordingly, if a current block is encoded in an intra-prediction mode, the decoder derives the prediction mode of a current block in order to perform prediction.

The decoder checks whether neighboring samples of the current processing block may be used for prediction and configures reference samples to be used for prediction (S502).

In intra-prediction, neighboring samples of a current processing block mean a sample neighboring the left boundary of the current processing block of an nS×nS size, a total of 2×nS samples neighboring the left bottom of the current processing block, a sample neighboring the top boundary of the current processing block, a total of 2×nS samples neighboring the top right of the current processing block, and one sample neighboring the top left of the current processing block.

However, some of the neighboring samples of the current processing block have not yet been decoded or may not be available. In this case, the decoder may configure reference samples to be used for prediction by substituting unavailable samples with available samples.

The decoder may perform the filtering of the reference samples based on the intra-prediction mode (S503).

Whether the filtering of the reference samples will be performed may be determined based on the size of the current processing block. Furthermore, a method of filtering the reference samples may be determined by a filtering flag transferred by the encoder.

The decoder generates a prediction block for the current processing block based on the intra-prediction mode and the reference samples (S504). That is, the decoder generates the prediction block for the current processing block (i.e., generates a prediction sample within the current processing block) based on the intra-prediction mode derived in the intra-prediction mode derivation step S501 and the reference samples obtained through the reference sample configuration step S502 and the reference sample filtering step S503.

If the current processing block has been encoded in the INTRA_DC mode, in order to minimize the discontinuity of the boundary between processing blocks, at step S504, the left boundary sample of the prediction block (i.e., a sample within the prediction block neighboring the left boundary) and the top boundary sample (i.e., a sample within the prediction block neighboring the top boundary) may be filter.

Furthermore, at step S504, in the vertical mode and horizontal mode of the intra-angular prediction modes, as in the INTRA_DC mode, filtering may be applied to the left boundary sample or the top boundary sample.

This is described in more detail. If the current processing block has been encoded in the vertical mode or the horizontal mode, the value of a prediction sample may be derived based on a reference sample located in a prediction direction. In this case, a boundary sample that belongs to the left boundary sample or top boundary sample of the prediction block and that is not located in the prediction direction may neighbor a reference sample not used for prediction. That is, the distance from the reference sample not used for prediction may be much closer than the distance from the reference sample used for prediction.

Accordingly, the decoder may adaptively apply filtering on left boundary samples or top boundary samples depending on whether an intra-prediction direction is a vertical direction or a horizontal direction. That is, the decoder may apply filtering on the left boundary samples if the intra-prediction direction is the vertical direction, and may apply filtering on the top boundary samples if the intra-prediction direction is the horizontal direction.

Hereinafter, inter prediction will be described in more detail.

Inter-Prediction

An inter-prediction means a prediction method of deriving a current process block based on a data element (e.g., sample value or motion vector, etc.) of a picture in addition to a current picture. That is, the inter-prediction means a method of predicting a pixel value of the current process block by referring to reconstructed regions in other reconstructed picture except the current picture.

The inter-prediction (or prediction between pictures) is a technique of removing redundancy existed between pictures, and performed by motion estimation and motion compensation, largely.

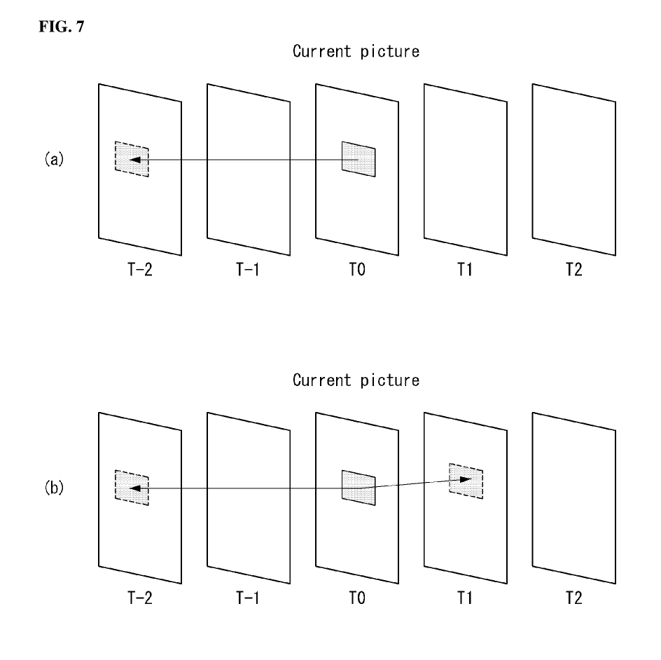

FIG. 7 is a diagram illustrating a direction of an inter-prediction as an embodiment to which the present invention may be applied.

Referring to FIG. 7, an inter-prediction may be divided into Uni-directional prediction that uses only one of a past picture or a future picture as a reference picture on a time axis for a block and Bi-directional prediction that refers past and future pictures simultaneously.

In addition, the Uni-directional prediction may be divided into forward direction prediction that uses a single reference picture displayed (or output) before a current picture temporally and backward direction prediction that uses a single reference picture displayed (or outputted) after a current picture temporally.

The motion parameter (or information) used for specifying a reference region (or reference block) for predicting a current block in the inter-prediction process (i.e., Uni-directional or Bi-directional prediction) includes an inter-prediction mode (herein, the inter-prediction mode may indicate a reference direction (i.e., Uni-directional or Bi-directional) and a reference list (i.e., L0, L1 or Bi-directional)), a reference index (or reference picture index or a reference list index), and motion vector information. The motion vector information may include a motion vector, a motion vector prediction (MVP) value or a motion vector difference (MVD) value. The motion vector difference (MVD) value means a difference value between the motion vector and the motion vector prediction value.

The Uni-directional prediction uses a motion parameter for a direction. That is, a single motion parameter may be required to specify a reference region (or reference block).

The Bi-directional prediction uses a motion parameter for both directions. Maximum two reference regions may be used in the Bi-directional prediction scheme, and the two reference regions may be existed in the same reference picture or existed in different pictures, respectively. That is, maximum two motion parameters may be used in the Bi-directional prediction scheme, two motion vectors may have the same reference picture index or different picture indexes. At this time, all of the reference pictures may be displayed (or outputted) before the current picture temporally or displayed (or outputted) after the current picture temporally.

An encoder performs motion estimation of finding a reference region which is the most similar reference region to a current process block in the inter-prediction process. In addition, the encoder may provide a motion parameter for a reference region to a decoder.

Encoder/decoder may obtain a reference region of a current process block by using a motion parameter. The reference region exists in a reference picture having the reference index. In addition, a pixel value or an interpolated value of the reference region which is specified by the motion vector may be used as a predictor of the current process block. That is, by using the motion information, the motion compensation is performed for predicting an image of the current process block from a previously decoded picture.

In order to decrease an amount of transmission in relation to motion vector information, a method of obtaining a motion vector prediction value (mvp) by using motion information of previously coded blocks and transmitting only a difference value (mvd) for it may be used. That is, a decoder calculates a motion vector prediction value of a current process block by using the motion information of other blocks that are decoded, and obtains the motion vector value for the current process block by using the difference value transmitted from an encoder. When obtaining a motion vector prediction value, the decoder may obtain various motion vector candidate values by using the motion information of other blocks that are already decoded, and may obtain one of them as a motion vector prediction value.

Reference Picture Set and Reference Picture List

In order to manage multiple reference pictures, a set of pictures that are previously decoded is stored in a decoded picture buffer (DPB) for decoding the remaining pictures.

The reconstructed picture used for an inter-prediction among the reconstructed pictures stored in the DPB is referred to as a reference picture. In other words, a reference picture means a picture including a sample that may be used for an inter-prediction in the next decoding process of a picture in the decoding order.

The reference picture set (RPS) means a set of reference pictures associated with a picture, and is configured by all pictures associated previously in the decoding order. The reference picture set may be used for an inter-prediction of an associated picture or a picture that follows the associated picture in the decoding order. That is, the reference picture maintained in the DPB may be referred to as a reference picture set. An encoder may provide a sequence parameter set (SPS) (i.e., a syntax structure including syntax elements) or reference picture set information to a decoder in each slice header.

The reference picture list means a list of a reference picture used for an inter-prediction of P picture (or slice) or B picture (or slice). Here, the reference picture list may divided into two reference picture lists, and may be referred to as reference picture list 0 (or L0) and reference picture list 1 (or L1), respectively. In addition, the reference picture belonged to reference picture list 0 is referred to as reference picture 0 (or L0 reference picture) and the reference picture belonged to reference picture list 1 is referred to as reference picture 1 (or L1 reference picture).

In the decoding process of P picture (or slice), a single reference picture list (i.e., reference picture list 0) is used, and in the decoding process of B picture (or slice), two reference picture list (i.e., reference picture list 0 and reference picture list 1) may be used. The information for distinguishing a reference picture list for each reference picture may be provided to a decoder through reference picture set information. The decoder adds a reference picture in reference picture list 0 and reference picture list 1 based on the reference picture set information.

A reference picture index (or reference index) is used for distinguishing a single specific reference picture in the reference picture list.

Fractional Sample Interpolation

A sample of a prediction block for an inter-predicted current process block is obtained from a sample value of a corresponding reference region in a reference picture identified by a reference picture index. Here, the corresponding reference region in a reference picture represents a region of a position indicated by a horizontal component and a vertical component of a motion vector. Except the case that a motion vector has an integer value, the fractional sample interpolation is used for generating prediction samples for a non-integer sample coordinate. For example, a motion vector of 1/4 unit of a distance between samples may be supported.

For HEVC, the fractional sample interpolation of a luminance component applies 8-tap filter in a horizontal direction and a vertical direction, respectively. In addition, the fractional sample interpolation of color component applies 4-tap filter in a horizontal direction and a vertical direction, respectively.

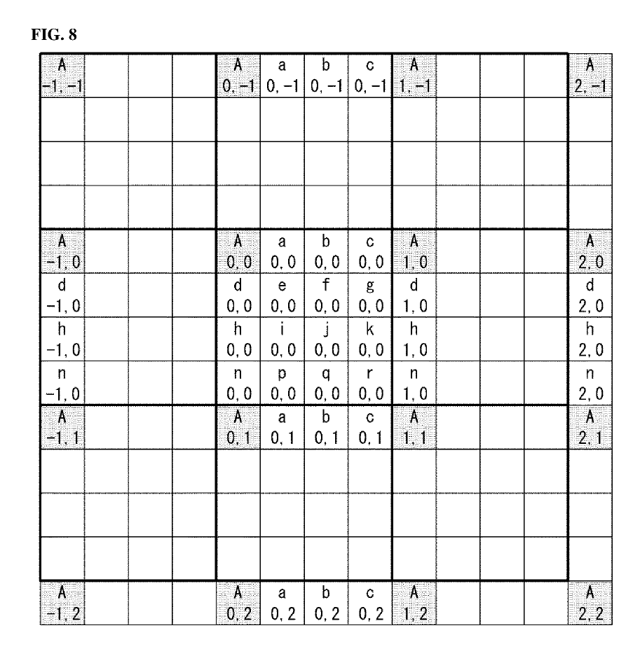

FIG. 8 illustrates an integer and fractional sample position for ¼ sample interpolation as an embodiment to which the present invention may be applied.

Referring to FIG. 8, a shaded block in which upper-case letter (A_i, j) is written indicates an integer sample position, and a block with no shade a lower-case letter (x_i, j) is written indicates a fractional sample position.

The fractional sample is generated by an interpolation filter being applied to an integer sample value in a horizontal direction and a vertical direction. For example, in the case of horizontal direction, 8-tap filter may be applied to 4 integer sample values in left side and integer sample values in right side based on a fractional sample to generate.

Inter-Prediction Mode

In HEVC, a Merge mode and an Advanced Motion Vector Prediction (AMVP) may be used for decreasing amount of motion information.

1) Merge Mode

Merge mode means a method of deriving a motion parameter (or information) from neighboring blocks spatially or temporally.

In the Merge mode, a set of available candidates includes spatial neighbor candidates, temporal candidates and generated candidates.

FIG. 9 illustrates a position of spatial candidate as an embodiment to which the present invention may be applied.

Referring to FIG. 9(a), it is determined whether each spatial candidate is available according to an order of {A1, B1, B0, A0, B2}. At this time, in the case that a candidate block is encoded in an inter-prediction mode and motion information is not existed or in the case that a candidate block is located outside a current block (or slice), the corresponding candidate block is unable to be used.

After determining a validation of a spatial candidate, a spatial merge candidate may be constructed by excluding unnecessary candidate block from the candidate block of a current process block. For example, in the case that a candidate block of the current prediction block is the first prediction block in the same coding block, the corresponding candidate block may be excluded or the candidate blocks having the same motion information may also be excluded.

When the spatial merge candidate construction is completed, a temporal merge candidate configuration process is progressed in an order of {T0, T1}.

In the temporal merge candidate configuration, in the case that a right bottom block T0 of a collocated block of a reference picture is available, the corresponding block is configured as a temporal merge candidate. The collocated block means a block existed in a position corresponding to a current process block in a selected reference picture. On the contrary, the block T1 positioned in a center of a collocated block is configured as a temporal merge candidate, otherwise.

The maximum number of merge candidates may be specified in a slice header. In the case that the number of merge candidates is greater than the maximum number, spatial candidates and temporal candidates of the number smaller than the maximum number are maintained. Otherwise, as the numbers of merge candidates, the candidates added up to now are combined until the number of candidates becomes the maximum number, and the additional merge candidates (i.e., combined bi-predictive merging candidates) are generated.

An encoder configures a merge candidate list in such a method and performs Motion Estimation, and signals the candidate block information selected in the merge candidate list as a merge index (e.g., merge_idx[x0][y0]′) to a decoder. FIG. 9(b) shows the case that B1 block is selected in the merge candidate list, and in this case, “index 1” may be signaled as a merge index to the decoder.

The decoder configures a merge candidate list in the same way as the encoder, and derives motion information in the merge candidate list for a current block from the motion information of a candidate block corresponding to a merge index which is received from the encoder. In addition, the decoder generates a prediction block for the current process block based on the derived motion information (i.e., motion compensation).

2) Advanced Motion Vector Prediction (AMVP) Mode

AMVP mode means a method of deriving a motion vector prediction value from a neighboring block. Accordingly, horizontal and vertical motion vector difference (MVD), and a reference index and an inter-prediction mode are signaled to a decoder. The horizontal and vertical motion vector value is calculated by using the derived motion vector prediction value and the motion vector difference (MVD) provided in the encoder.

That is, the encoder configures a motion vector prediction candidate list, and performs Motion Estimation, and signals the motion reference flag (i.e., candidate block information) (e.g., mvp_1X_flag[x0][y0]′) selected in the motion vector prediction candidate list to a decoder. The decoder configures a motion vector prediction candidate list in the same way as the encoder, and derives motion vector prediction value of a current process block by using the motion information of the candidate block indicated in the motion reference flag received from the encoder. In addition, the decoder obtains a motion vector value for a current process block by using the derived motion vector prediction value and the motion vector difference value transmitted from the encoder. And the decoder generates a prediction block for the current process block based on the derived motion information (i.e., motion compensation).

In the case of the AMVP mode, among the 5 available candidates in FIG. 9 above, two spatial motion candidates are selected. The first spatial motion candidate is selected from {A0, A1} set located in the left side, and the second spatial motion candidate is selected from {B0, B1, B2} set located in the top side. At this time, in the case that a reference index of a neighboring candidate block is not identical to the current prediction block, a motion vector is scaled.

As a result of a search of the spatial motion candidates, in the case that the number of candidates is two, the candidate configuration is completed, but in the case that the number of candidates is less than two, a temporal motion candidate is added.

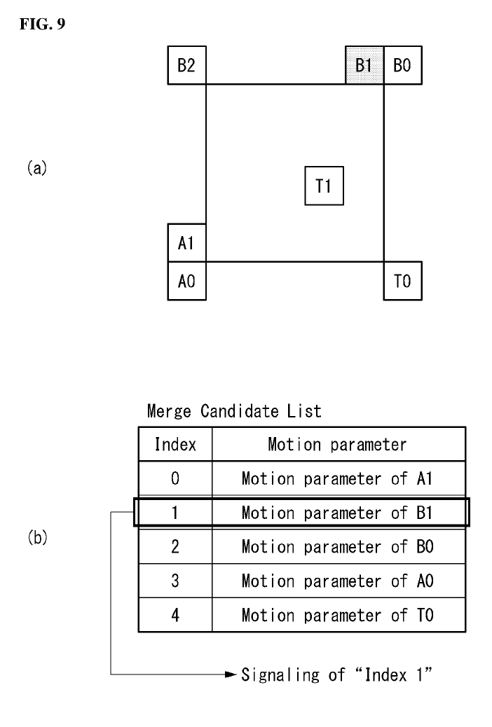

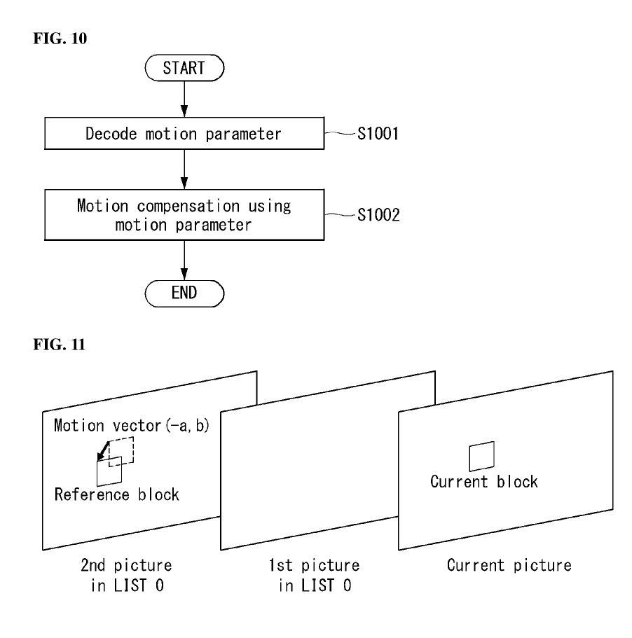

FIG. 10 is a diagram illustrating an inter-prediction method as an embodiment to which the present invention is applied.

Referring to FIG. 10, a decoder (particularly, an inter-prediction unit 261 in FIG. 2) decodes a motion parameter for a process block (e.g., prediction unit) (step, S1001).

For example, in the case that the merge mode is applied to a process block, the decoder may decode a merge index which is signaled from an encoder. In addition, the decoder may derive a motion parameter of a current process block from the motion parameter of the candidate block which is indicated by the merge index.

Furthermore, in the case that the AMVP mode is applied to a process block, the decoder may decode horizontal and vertical motion vector difference (MVD) values which is signaled from the encoder, and may decode a reference index and an inter-prediction mode. In addition, the decoder may derive a motion vector prediction value from the motion parameter of the candidate block indicated by a motion reference flag, and may derive a motion vector value of the current process block by using a motion vector prediction value and the received motion vector difference value.

The decoder performs a motion compensation for a prediction unit by using the decoded motion parameter (or information) (step, S1002).

That is, the encoder/decoder performs a motion compensation for predicting an image of a current unit from the previously decoded picture by using the decoded motion parameter.

FIG. 11 is a diagram illustrating a motion compensation procedure as an embodiment to which the present invention is applied.

FIG. 11 illustrates the case that the motion parameter for a current block to encode in a current picture is the Uni-directional prediction, LIST0, the second picture in LIST0 and a motion vector (-a, b).

In this case, the current block is predicted by using the values (i.e., sample values of a reference block) in the position which is away as much as (-a, b) from the current block in the second picture of LIST0.

For the Bi-directional prediction, another reference list (e.g., LIST1) and a reference index, and a motion vector difference value are transmitted, and a decoder derives two reference blocks and predict the current block value based on it.

Generally, a selection of a prediction block is performed by a method of determining a block of which Rate-Distortion Cost (RD cost) becomes minimum as an optimal block. Equation 1 represents an RD cost calculation formula.

RDcost=D+λ [Equation 1 ]

In Equation 1, D represents Distortion, and R represents Rate. In addition, λ represents a variable for adjusting Rate value. The Distortion is calculated by Sum of Square Difference (SSD) of a block of an original image and a reconstructed block, and the Rate is calculated by considering a bit required when encoding motion information and mode information, and so on.

Image Processing Method Based on Joint Inter-Intra Prediction

The present invention proposes a method for encoding/decoding an image based on a Joint inter-intra prediction mode, which is a new prediction mode in order to improve an accuracy of a prediction. In addition, the present invention proposes a method of generating a new prediction block by providing a weight to a prediction block between images (inter-prediction block) or a prediction block within an image (intra-prediction block).

The Joint inter-intra prediction (joint prediction between images and within an image) method means a method of generating a prediction block of a current block by combining an inter-prediction block and an intra-prediction block.

The Joint inter-intra prediction mode is a new prediction mode and also called as another name, but the term of the mode is not necessarily limited to ‘Joint inter-intra prediction mode’ or ‘joint prediction mode between images and within an image’.

Hereinafter, the Image processing method based on Joint inter-intra prediction will be described.

FIG. 12 illustrates a schematic block diagram of an encoder including a Joint inter-intra prediction unit as an embodiment to which the present invention is applied.

Referring to FIG. 12, an encoder includes a picture split unit 1210, a subtraction unit 1215, a transform unit 1220, a quantization unit 1230, a dequantization unit 1240, an inverse transform unit 1250, a filtering unit 1260, a decoded picture buffer (DPB) 1270, an inter-prediction unit 1281, an intra-prediction unit 1282, a joint inter-intra prediction unit 1283 and an entropy encoding unit 1290.

The picture split unit 1210 splits an input video signal (or picture or frame), input to the encoder, into one or more processing units.

The subtraction unit 1215 generates a residual signal (or residual block) by subtracting a prediction signal (or prediction block), output from the inter-prediction unit 1281, the intra-prediction unit 1282 or the joint inter-intra prediction unit 1283 from the input video signal. The generated residual signal (or residual block) is transmitted to the transform unit 1220.

The transform unit 1220 generates transform coefficients by applying a transform scheme (e.g., discrete cosine transform (DCT), discrete sine transform (DST), graph-based transform (GBT) or Karhunen-Loeve transform (KLT)) to the residual signal (or residual block). In this case, the transform unit 1220 may generate the transform coefficients by performing transform using a determined transform scheme depending on a prediction mode applied to the residual block and the size of the residual block.

The quantization unit 1230 quantizes the transform coefficient and transmits it to the entropy encoding unit 1290, and the entropy encoding unit 1290 performs an entropy coding operation of the quantized signal and outputs it as a bit stream.

Meanwhile, the quantized signal that is outputted from the quantization unit 1230 may be used for generating a prediction signal. For example, by applying dequantization and inverse transformation to the quantized signal through the dequantization unit 1240 and the inverse transform unit 1250, the residual signal may be reconstructed. By adding the reconstructed residual signal to the prediction signal that is outputted from the inter-prediction unit 1281, the intra-prediction unit 1282, or the joint inter-intra prediction unit 1283, a reconstructed signal may be generated.

The filtering unit 1260 applies filtering to the reconstructed signal, and outputs it through a play-back device or transmits it to the decoded picture buffer 1270. The filtered signal transmitted to the decoded picture buffer 1270 may be used as a reference picture in the inter-prediction unit 1281 or the joint inter-intra prediction unit 1283. As such, by using the filtered picture as a reference picture in an inter-prediction mode or , the encoding rate as well as the image quality may be improved.

The decoded picture buffer 1270 may store the filtered picture in order to use it as a reference picture in the inter-prediction unit 1281.

The inter-prediction unit 1281 performs a temporal prediction and/or a spatial prediction by referring to the reconstructed picture in order to remove a temporal redundancy and/or a spatial redundancy.

The intra-prediction unit 1282 predicts the current block by referring to the samples adjacent the block that is to be encoded currently. The intra-prediction unit 1282 may perform the following procedure in order to perform the intra-prediction. First, the intra-prediction unit 1282 may prepare a reference sample that is required for generating a prediction signal. Furthermore, the intra-prediction unit 1282 may generate a prediction signal by using the reference sample prepared. Later, the intra-prediction unit 1282 may encode the prediction mode. In this case, the reference sample may be prepared through reference sample padding and/or reference sample filtering. Since the reference sample goes through the prediction and the reconstruction process, a quantization error may be existed. Accordingly, in order to decrease such an error, the reference sample filtering process may be performed for each prediction mode that is used for the intra-prediction.

The prediction signal (or prediction block) generated through the inter-prediction unit 1281, the intra-prediction unit 1282 or the Joint inter-intra prediction unit 1283 may be used for generating a reconstructed signal (or reconstructed block) or used for generating a residual signal (or residual block).

The Joint inter-intra prediction unit 1283 may generate an inter-prediction block (or prediction block between images) by referring to a reconstructed picture, and may generate an intra-prediction block (or prediction block within an image) by performing an intra-prediction. Further, the Joint inter-intra prediction unit 1283 may generate a joint inter-intra prediction block by combining an inter-prediction block and an intra-prediction block. The detailed description for it will be described below.

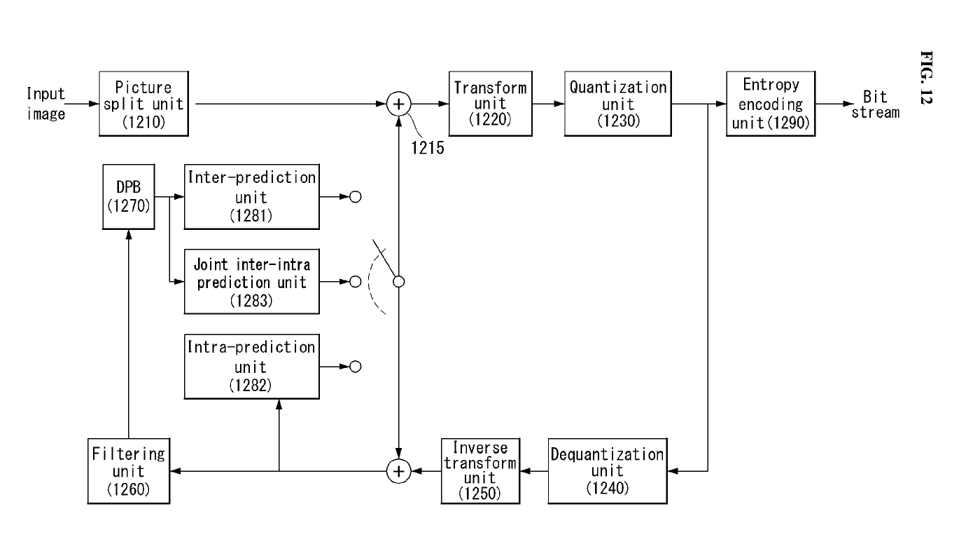

FIG. 13 illustrates a schematic block diagram of a decoder including a Joint inter-intra prediction unit as an embodiment to which the present invention is applied.

Referring to FIG. 13, a decoder may include an entropy decoding unit 1310, a dequantization unit 1320, an inverse transform unit 1330, an adder 1335, a filtering unit 1340, a decoded picture buffer (DPB) 1350, an inter-prediction unit 1361, an intra-prediction unit 1362 and a Joint inter-intra prediction unit 1363.

Furthermore, the reconstructed video signal outputted through the decoder may be played through a play-back device.

The decoder receives the signal (i.e., bit stream) outputted from the encoder shown in FIG. 12, and the entropy decoding unit 1310 performs an entropy decoding operation of the received signal.

The dequantization unit 1320 obtains a transform coefficient from the entropy-decoded signal using quantization step size information.

The inverse transform unit 1330 obtains a residual signal (or residual block) by inversely transforming transform coefficients using an inverse transform technique.

The adder 1335 adds the obtained residual signal (or residual block) to the prediction signal (or prediction block) output by the inter-prediction unit 1361, the intra-prediction unit 1362 or the Joint inter-intra prediction unit 1363, thereby generating a reconstructed signal (or reconstructed block).

The filtering unit 1340 applies filtering to the reconstructed signal (or reconstructed block) and outputs it to a playback device or transmits it to the decoded picture buffer 1350. The filtered signal transmitted to the decoded picture buffer 1350 may be used as a reference picture in the inter-prediction unit 1361 or the Joint inter-intra prediction unit 1363.

In this disclosure, the embodiments described in the filtering unit 1260, the inter-prediction unit 1281, the intra-prediction unit 1282 and the Joint inter-intra prediction unit 1263 of the encoder may also be applied to the filtering unit 1340, the inter-prediction unit 1361, the intra-prediction unit 1362 and the Joint inter-intra prediction unit 1363 of the decoder, respectively, in the same way.

Particularly, the Joint inter-intra prediction unit 1363 may generate an inter-prediction block (or prediction block between images) by referring to a reconstructed picture, and may generate an intra-prediction block (or prediction block within an image) by performing an intra-prediction. Further, the Joint inter-intra prediction unit 1363 may generate a Joint inter-intra prediction block by combining an inter-prediction block and an intra-prediction block. This will be described below in detail.

The joint inter-intra prediction generates a Joint inter-intra prediction block by combining an inter-prediction block and an intra-prediction block. Hereinafter, in describing the present invention, the case of generating an inter-prediction block first, and then an intra-prediction block is mainly described, but the present invention is not limited thereto. That is, an inter-prediction block may be generated first, and then an intra-prediction block may be generated. In addition, an intra-prediction block may be generated first, and then an inter-prediction block may be generated.

Hereinafter, as an embodiment of the present invention, an image processing method is described based on the Joint inter-intra prediction mode in the case that an intra-prediction mode is transmitted to a decoder.

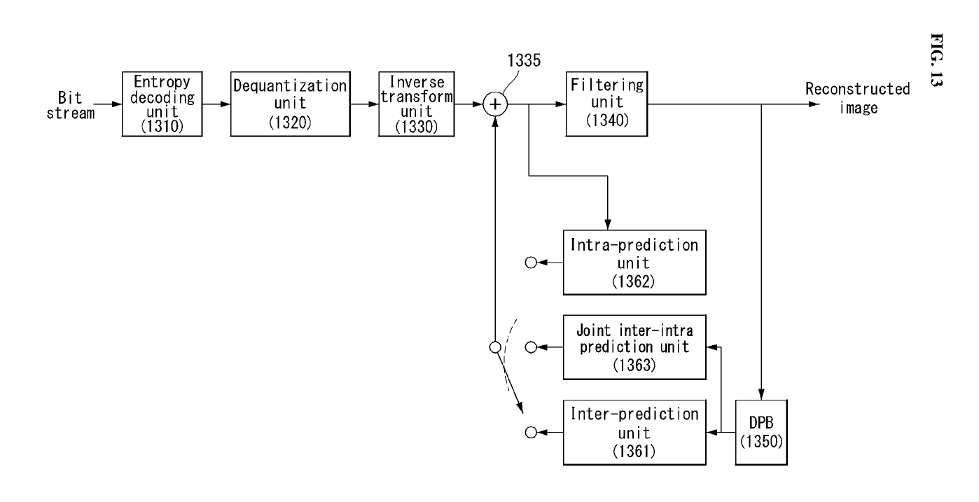

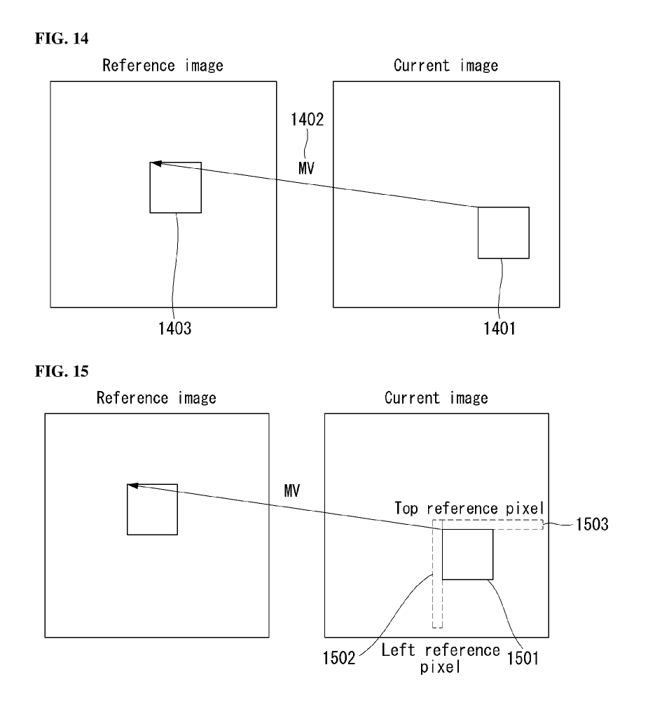

In the case that a prediction mode of a current block is the Joint inter-intra prediction mode, the decoder generates an inter-prediction block and an intra-prediction block. First, a method of generating an inter-prediction block is described by referring to FIG. 14.

FIG. 14 is a diagram illustrating a method of generating an inter-prediction block according to an embodiment of the present invention.

Referring to FIG. 14, in the case that a prediction mode of a current block 1401 is the Joint inter-intra prediction mode, the decoder may derive motion information 1402 in order to perform an inter-prediction. By using the motion information 1402 which is derived, the decoder may perform the motion compensation that generates an inter-prediction block of the current block 1401 from the previously decoded reference picture (or reference image).

The motion compensation that generates an inter-prediction block of the current block 1401 based on the motion information 1402 may be performed as below.

By using the motion information 1402 of the current block 1401, a reference block 1403 may be identified in a reference image, and an inter-prediction sample value of the current block 1401 may be generated as the sample value of the reference block 1403. In this case, the motion information 1402 may include all types of information required for distinguishing the reference block 1403 in the reference image.

For example, the motion information 1402 may include a reference list (i.e., may indicates L0, L1 or both directions), a reference index (or reference picture index) and motion vector information. That is, a reference image may be selected by using the reference list (i.e., may indicates L0, L1 or both directions) and the reference index (or reference picture index), and the reference block 1403 corresponding to the current block 1401 may be identified by using the motion vector in the reference image.

In addition, all of the reference list (i.e., may indicates L0, L1 or both directions), the reference index (or reference picture index) and the motion vector information may be transmitted to the decoder, but the merge mode or the AMVP mode may be used for decreasing the traffic in relation to the motion vector information.

For example, in the case that the merge mode is applied to the current block 1401, the decoder may decode a merge index which is signaled from an encoder. Further, the motion information 1402 of the current block 1401 may be derived from the motion parameter of a candidate block which is indicated in a merge index.

In addition, in the case that the AMVP mode is applied to the current block 1401, the decoder may decode a motion vector difference (MVD), a reference index and an inter-prediction mode that are signaled from the encoder. Further, a motion vector prediction value is derived from a motion parameter of a candidate block indicated from a motion reference flag (i.e., candidate block information), and motion vector information is derived by using a motion vector prediction value and the received motion vector difference (MVD), and accordingly, the motion information 1402 of the current block 1401 may be derived.

By using the derived motion information 1402, the reference block 1403 is identified in the reference image, and an inter-prediction block of the current block may be generated using the sample value of the reference block 1403 (motion compensation).

When the encoder transmits an intra-prediction mode to the decoder, a method for the decoder to generate an intra-prediction block is described by performing an intra-prediction.

FIG. 15 is a diagram illustrating a method of generating an intra-prediction block according to an embodiment of the present invention.

Referring to FIG.15, when a prediction mode within an image (intra-prediction mode) is transmitted from an encoder, a prediction block within an image (intra-prediction block) may be generated by using neighboring reference pixels (or reference samples) 1502 and 1503 of a current block 1501.

That is, based on the transmitted intra-prediction mode, a reference sample used for the intra-prediction may be determined between the neighboring samples f1502 and 1503 of the current block 1501 in the current image, and an intra-prediction sample value of the current block 1501 may be generated from the determined reference sample.

The neighboring reference samples (or reference samples) 1502 and 1503 mean a sample adjacent to a left boundary of the current block of nS×nS size and total 2×nS samples neighboring a bottom-left, a single sample 1502 adjacent to a top-left of the current process block, a sample neighboring a top boundary of the current process block and total 2×nS samples 1503 neighboring a top-right.

A part of the samples 1502 and 1503 neighboring the current block 1501 may not be decoded yet or unavailable. In this case, the decoder may substitute the unavailable samples to available samples, and may configure reference samples that are going to be used for a prediction.

In addition, the decoder may perform filtering of a reference sample based on an intra-prediction mode. It may be determined based on a size of the current block 1501 whether to perform the filtering of the reference sample. A method of filtering the reference sample may be determined by a filtering flag which is forwarded from the encoder.

That is, the decoder may derive an intra-prediction mode of the current block 1501 and may configure the reference samples used for a prediction by checking whether the samples 1502 and 1503 neighboring the current block 1501 is available to be used for a prediction, and the decoder may perform filtering of the reference sample based on the intra-prediction mode.

The decoder generates an intra-prediction block for the current process block based on the derived intra-prediction mode and the reference samples used for a prediction among the neighboring samples 1502 and 1503.

The decoder generates an inter-prediction block and an intra-prediction block, and generates a joint inter-intra prediction block by combining the inter-prediction block and the intra-prediction block.

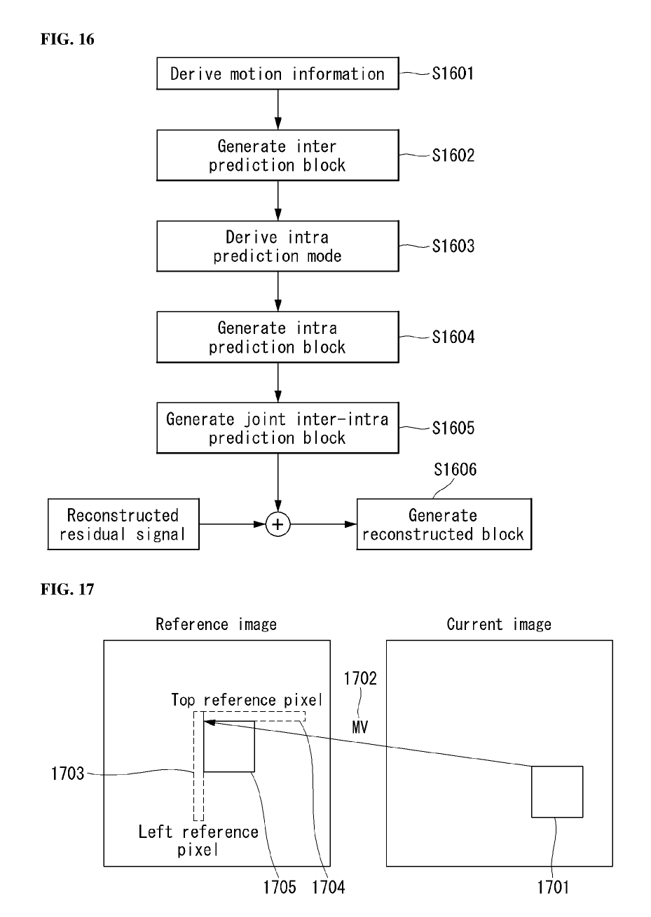

FIG. 16 is a diagram illustrating an image processing method based on a joint inter-intra prediction mode according to an embodiment of the present invention.

By referring to FIG. 16, in the case that an intra-prediction mode is transmitted from an encoder, a method for generating a reconstructed block by performing a Joint prediction block between images and within an image (Joint inter-intra prediction) in a decoder is described. As described above, the case of an inter-prediction block is generated first is mainly described.

First, a decoder derives motion information (step, S1601). As described above, the motion information may include all types of information required for distinguishing a reference block in a reference image.

For example, the motion information may include a reference list (i.e., may indicates L0, L1 or both directions), a reference index (or reference picture index) and motion vector information. That is, a reference image may be selected by using the reference list (i.e., may indicates L0, L1 or both directions) and the reference index (or reference picture index), and the reference block corresponding to the current block may be identified by using the motion vector in the reference image.

In addition, all of the reference list (i.e., may indicates L0, L1 or both directions), the reference index (or reference picture index) and the motion vector information may be transmitted to the decoder, but the merge mode or the AMVP mode may be used for decreasing the traffic in relation to the motion vector information.

For example, in the case that the merge mode is applied to the current block, the decoder may decode a merge index which is signaled from an encoder. Further, the motion information of the current block may be derived from the motion parameter of a candidate block which is indicated in a merge index.

In addition, in the case that the AMVP mode is applied to the current block, the decoder may decode a motion vector difference (MVD), a reference index and an inter-prediction mode that are signaled from the encoder. Further, a motion vector prediction value is derived from a motion parameter of a candidate block indicated from a motion reference flag (i.e., candidate block information), and motion vector information is derived by using a motion vector prediction value and the received motion vector difference (MVD), and accordingly, the motion information of the current block may be derived.

By using the derived motion information, the decoder generates a prediction block between images (inter-prediction block) (step, S1602). That is, the decoder may identify the reference block in the reference image, and may generate an inter-prediction block of the current block using the sample value of the reference block (motion compensation).

The decoder derives an intra-prediction mode from the information received from the encoder (step, S1603). Based on the transmitted intra-prediction mode, a reference sample used for the intra-prediction may be determined among the neighboring samples of the current block.

The decoder generates a prediction block within an image (intra-prediction block) for the current block based on the derived intra-prediction mode and the reference samples used for a prediction among the reference pixels (or reference samples) neighboring the current block within the image which is currently reconstructed (step, S1604).

The decoder generates an inter-prediction block and an intra prediction block, and generates a Joint inter-intra prediction block by combining the inter-prediction block and the prediction block within an image (step, S1605).

In this case, a Joint inter-intra prediction block may be generated by applying respective weights and combining the inter-prediction block and the intra prediction block. This will be described in detail below.

The decoder reconstructs a residual signal transmitted from the encoder, and generates a reconstructed block by combining it with the Joint inter-intra prediction block (step, S1606).

So far, the Joint prediction method between images and within an image has been described in the case that an encoder transmits an intra-prediction mode. Hereinafter, a Joint prediction method between images and within an image is described in the case that an encoder does not transmit an intra-prediction mode.

In order to perform Joint prediction between images and within an image, a decoder may generate an inter-prediction block and an intra-prediction block. Even in the case that the prediction block within an image is not transmitted; an inter-prediction block may be generated in the same way as described in FIG. 14.

A method for generating prediction block within an image is described in the case that the prediction block within an image is not transmitted with reference to FIG. 17.

FIG. 17 is a diagram illustrating a method for generating an intra-prediction block according to an embodiment of the present invention.

Referring to FIG. 17, after generating an inter-prediction block, a prediction within an image may be performed by using reference pixels (or reference samples) 1703 and 1704 neighboring a selected block (i.e., a block specified by a motion vector of a current block) as an inter-prediction block in a reference image. Since an intra-prediction mode is not transmitted, a decoder may determine an intra-prediction mode in the same way as an encoder, and may generate prediction block within an image based on the determined intra-prediction mode.

The neighboring reference samples (or reference samples) may mean a sample adjacent to a left boundary of the block 1705 selected as an inter-prediction block in a reference image of nS×nS size and total 2×nS samples neighboring a bottom-left, a single sample 1703 neighboring a top-left of the block selected as an inter-prediction block in a reference image, a sample adjacent to a top boundary of the block selected as an inter-prediction block in a reference image and total 2×nS samples 1704 neighboring a top-right.

Since an intra-prediction mode is not transmitted from the encoder, the decoder is needed to determine an optimal intra-prediction mode by performing an intra-prediction in the same way as the encoder.

In this case, since the decoder is unable to compare an original image with a prediction sample when determining an intra-prediction mode, the decoder may determine an intra-prediction mode by comparing an inter-prediction block with the prediction block within an image which is generated by performing a prediction within an image in a reference image.

That is, the decoder performs a prediction within an image by using the inter-prediction block generated by performing a prediction between images and the neighboring pixels (or reference samples) 1703 and 1704 neighboring the sample 1705 selected as an inter-prediction block in a reference image.

The decoder may perform an intra-prediction by using the reference pixels (left and bottom-left samples, a single top-left sample 1703, top and top-right samples 1704) neighboring the block 1705 corresponding to the current block 1701 in a reference image, and may generate an intra-prediction block based on the determined intra-prediction mode.

Hereinafter, a method for determining an intra-prediction mode is exemplified and described in the same way as the encoder.

In the case that an intra-prediction mode is not transmitted, the decoder may determine an intra-prediction mode by obtaining a Rate-Distortion Cost (RD cost) value in the same way as the encoder.

The Rate-Distortion Cost (RD cost) value may be calculated from a summation of a Distortion and a Rate. Since an intra-prediction is performed in a reference image, not a current image, the calculation of the Distortion and the Rate may be differently performed from the case that an intra-prediction mode is transmitted to the decoder.

For example, the Distortion value may be calculated as a Sum of Square Difference (SSD) of the inter-prediction block generated through a prediction between images and the prediction block within an image generated by using the reference pixels 1703 and 1704 neighboring the block corresponding to the current block in a reference image, and the Rate value may be calculated by considering a bit required when encoding residual information in which an intra-prediction block is subtracted.

The encoder or the decoder may calculate the RD cost value of the prediction block within an image generated by using all available intra-prediction modes, and may determine the intra-prediction mode of which RD cost value becomes a minimum to be the intra-prediction mode of the current block.

As described above, in the case that an intra-prediction mode is not transmitted, the decoder may determine an optimal intra-prediction mode and may generate an intra prediction block based on the determined intra-prediction mode. The decoder may generate a joint inter-intra prediction block by combining the inter-prediction block and the prediction block within an image that are generated.

Hereinafter, in the case that an intra-prediction mode is not transmitted to a decoder, a method of generating a reconstructed block is described.

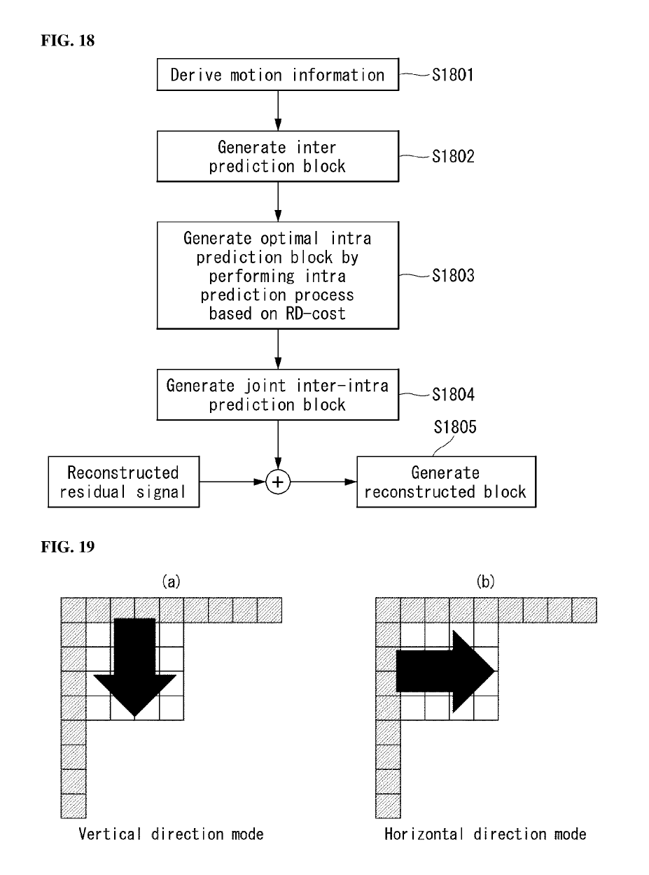

FIG. 18 is a diagram illustrating an image processing method based on a Joint inter-intra prediction mode according to an embodiment of the present invention.

First, a decoder derives motion information from the information transmitted from an encoder (step, S1801). As described above, the motion information may include all types of information required for distinguishing a reference block within a reference image.

For example, the motion information may include a reference list (i.e., may indicates L0, L1 or both directions), a reference index (or reference picture index) and motion vector information. That is, a reference image may be selected by using the reference list (i.e., may indicates L0, L1 or both directions) and the reference index (or reference picture index), and the reference block corresponding to the current block may be identified by using the motion vector in the reference image.

In addition, all of the reference list (i.e., may indicates L0, L1 or both directions), the reference index (or reference picture index) and the motion vector information may be transmitted to the decoder, but the merge mode or the AMVP mode may be used for decreasing the traffic in relation to the motion vector information.

For example, in the case that the merge mode is applied to the current block, the decoder may decode a merge index which is signaled from an encoder. Further, the motion information of the current block may be derived from the motion parameter of a candidate block which is indicated in a merge index.

In addition, in the case that the AMVP mode is applied to the current block, the decoder may decode a motion vector difference (MVD), a reference index and an inter-prediction mode that are signaled from the encoder. Further, a motion vector prediction value is derived from a motion parameter of a candidate block indicated from a motion reference flag (i.e., candidate block information), and motion vector information is derived by using a motion vector prediction value and the received motion vector difference (MVD), and accordingly, the motion information of the current block may be derived.

By using the derived motion information, the decoder generates a prediction block between images (inter-prediction block) (step, S1802). That is, the decoder may identify the reference block in the reference image, and may generate an inter-prediction block of the current block using the sample value of the reference block (motion compensation).

After generating an inter-prediction block, an optimal intra-prediction mode is determined by performing a prediction within an image within a reference image based on the Rate-Distortion Cost (RD cost), and an intra prediction block is generated based on the determined intra-prediction mode (step, S1803).

Since an intra-prediction mode is not transmitted from the encoder, the decoder is needed to an optimal intra-prediction mode by performing a prediction within an image in the same way as the encoder.

In this case, since the decoder is unable to compare an original image with a prediction sample when determining an intra-prediction mode, the decoder may determine an intra-prediction mode by comparing an inter-prediction block with the prediction block within an image which is generated by performing a prediction within an image in a reference image.

That is, the decoder performs a prediction within an image by using the inter-prediction block generated by performing a prediction between images and the neighboring pixels (or reference samples) 1703 and 1704 neighboring the sample 1705 selected as an inter-prediction block in a reference image.

In this case, the intra-prediction mode may be determined as a mode that minimizes a Rate-Distortion Cost (RD cost) of an intra-prediction block. That is, the decoder may calculate the RD cost value of an intra-prediction block which is generated by using all available intra-prediction modes, and may determine the intra-prediction mode that minimizes the RD cost value to be the intra-prediction mode of the current block.

The decoder may generate an intra-prediction block based on the determined intra-prediction mode.

The decoder generates an inter-prediction block and an intra-prediction block, and generates a Joint inter-intra prediction block by combining the inter-prediction block and the prediction block within an image (step, S1804). In this case, a Joint inter-intra prediction block may be generated by applying respective weights and combining the inter-prediction block and the prediction block within an image. This will be described in detail below.

After the decoder generates the inter-prediction block and an intra-prediction block, and generates a reconstructed block by combining it with a reconstructed residual signal (step, S1805).

Method for Determining a Weight

Weights may be applied to an inter-prediction block and an intra-prediction block, respectively, and a Joint inter-intra prediction block may be generated by combining the inter-prediction block and the prediction block within an image. A method is described for determining weights applied to the inter-prediction block and the prediction block within an image.

(1) Explicit Determination Method

An explicit determination method means a method that 1) an encoder determines a weight, and 2) transmits (signals) weight information to a decoder, 3) a decoder derives (induces) a weight value from the weight information.

A first weight (or wᵢₙₜₑᵣ(i,j)) means a weight applied to a prediction block between images (inter-prediction block), and a second weight (or wᵢₙₜᵣₐ(i,j)) means a weight applied to a prediction block within an image (intra-prediction block). Herein, i denotes a horizontal direction coordinate based on a top-left sample of a current block, and j denotes a vertical direction coordinate based on a top-left sample of a current block (i.e., the position of the top-left sample of the current block means i=0 and j=0).

Equation 2 exemplifies a mathematical formula for calculating a prediction block in the Joint prediction method between images and within an image.

\tilde{x}ᵢₙₜₑᵣ₊ᵢₙₜᵣₐ(i,j)=wᵢₙₜₑᵣ(i,j)* \tilde{x}ᵢₙₜₑᵣ(i,j)+wᵢₙₜᵣₐ(i,j)* \tilde{x}ᵢₙₜᵣₐ(i,j) [Equation 2]

Herein, \tilde{x}ᵢₙₜₑᵣ(i,j) denotes an inter-prediction block, and \tilde{x}ᵢₙₜᵣₐ(i,j) denotes an intra-prediction block.

1) First, an encoder may calculate a weight as below.

An encoder may determine wᵢₙₜₑᵣ(i,j) applied to a inter-prediction block and wᵢₙₜᵣₐ(i,j) applied to an intra-prediction block.

Each of wᵢₙₜₑᵣ(i,j) and wᵢₙₜᵣₐ(i,j) may be calculated by a Sum of Square Difference (SSD) in order to generate an inter-prediction block and an intra-prediction block.

That is, in the case that an SSD value used (or calculated) for generating an inter-prediction block is 100 and an SSD value used (or calculated) for generating an intra-prediction block is 50, the values of wᵢₙₜₑᵣ(i,j) and wᵢₙₜᵣₐ(i,j) may be determined to be ⅓ and ⅔, respectively, by considering the respective SSD values.

When a prediction within an image is performed and a prediction sample within an image is generated, since an accuracy of prediction may be degraded as a distance between a reference pixel and a prediction pixel of a current block increases, the encoder may reflect this and may adjust wᵢₙₜₑᵣ(i,j) and wᵢₙₜᵣₐ(i,j) in a pixel unit. That is, wᵢₙₜₑᵣ(i,j) applied to an inter-prediction block and wᵢₙₜᵣₐ(i,j) applied to an intra-prediction block may be weights applied in a unit of block or weights applied in a unit of pixel.

For example, as a distance between a reference pixel and a prediction pixel of a current block increases, the value of wᵢₙₜᵣₐ(i,j) may be adjusted to be smaller and the value of wᵢₙₜₑᵣ(i,j) may be adjusted to be greater. In this case, the condition wᵢₙₜₑᵣ(i,j)+wᵢₙₜᵣₐ(i,j)=1 is needed to be satisfied. This will be described with reference to the following drawing.

FIG. 19 is a diagram illustrating a method for determining a weight according to an embodiment of the present invention.

The case that a size of block to encode or decode currently is a 4x4 block is described for example.

For example, in the case that an SSD value used (or calculated) for generating an inter-prediction block is 50 and an SSD value used (or calculated) for generating an intra prediction block is 150, the values of wᵢₙₜₑᵣ(i,j) may be and wᵢₙₜᵣₐ(i,j) determined to be 0.75 and 0.25, respectively.

In this case, depending on the intra-prediction mode and a distance between a reference pixel and a prediction pixel, the values of wᵢₙₜₑᵣ(i,j) and wᵢₙₜᵣₐ(i,j) may be adjusted in a unit of pixel.

For example, as shown in FIG. 19(a), the intra-prediction mode is a vertical mode, the values of wᵢₙₜₑᵣ(i,j) and wᵢₙₜᵣₐ(i,j) may be changed according to a vertical direction coordinate. That is, depending on j value, the value of wᵢₙₜᵣₐ(i,j) may become smaller and the value of wᵢₙₜₑᵣ(i,j) may become greater.

On the other hand, as shown in FIG. 19(b), the intra-prediction mode is a horizontal mode, the values of wᵢₙₜₑᵣ(i,j) and wᵢₙₜᵣₐ(i,j) may be changed according to a horizontal direction coordinate. That is, depending on i value, the value of wᵢₙₜᵣₐ(i,j) may become smaller and the value of wᵢₙₜₑᵣ(i,j) may become greater.

Table 2 represents the values of wᵢₙₜₑᵣ(i,j) and wᵢₙₜᵣₐ(i,j) determined according to a horizontal direction coordinate i and a vertical direction coordinate j.

TABLE 2
Intra-prediction mode

| vertical direction mode | | | horizontal direction mode | | |
|---|---|---|---|---|---|
| (i, j) | wᵢₙₜₑᵣ (i, j) | wᵢₙₜₑᵣ (i, j) | (i, j) | wᵢₙₜₑᵣ (i, j) | wᵢₙₜₑᵣ (i, j) |
| (i, 0) | 0.75 | 0.25 | (0, j) | 0.75 | 0.25 |
| (i, 1) | 0.77 | 0.23 | (1, j) | 0.77 | 0.23 |
| (i, 2) | 0.79 | 0.21 | (2, j) | 0.79 | 0.21 |
| (i, 3) | 0.81 | 0.19 | (3, j) | 0.81 | 0.19 |

As represented in Table 2, in the case that an intra-prediction mode is a vertical direction mode, it may be adjusted that the value of wᵢₙₜᵣₐ(i,j) becomes smaller and the value of wᵢₙₜₑᵣ(i,j) becomes greater as the vertical direction coordinate j value increases.

In addition, in the case that an intra-prediction mode is a horizontal direction mode, as represented in Table 2, it may be adjusted that the value of wᵢₙₜᵣₐ(i,j) becomes smaller and the value of wᵢₙₜₑᵣ(i,j) becomes greater as the horizontal direction coordinate i value increases.

The weight table, Table 2 represents an example of a method for determining a weight, and an encoder may determine a ratio change of wᵢₙₜₑᵣ(i,j) and wᵢₙₜᵣₐ(i,j) depending on a prediction distance within an image in a different way from Table 2.

In addition, the encoder may determine a ratio of wᵢₙₜₑᵣ(i,j) and wᵢₙₜᵣₐ(i,j) to be adjusted in a unit of pixel depending on a distance between a reference pixel and a prediction pixel in an intra-prediction mode as well as the vertical mode or the horizontal mode.

2) The encoder may transmit information in relation to the weight which is determined to the decoder. The weight information may be transmitted in the following method.

The encoder may transmit the determined weight value to the decoder without any change. The weight applied in a unit of block may be transmitted without any change or the weight applied in a unit of pixel may be transmitted without any change.

The encoder and the decoder may store the weight in a table in advance, and the encoder may transmit a table index corresponding to the values of wᵢₙₜₑᵣ(i,j) and wᵢₙₜᵣₐ(i,j) to the decoder. For example, a plurality of tables like Table 2 may be stored and a table index selected among them may be transmitted to the decoder. In addition, the weight table stored by the encoder and the decoder in advance may be a weight table applied in a unit of block or a weight table applied in a unit of pixel.

The encoder may transmits initial values (values when i=0 and j=0) of wᵢₙₜₑᵣ(i,j) and wᵢₙₜᵣₐ(i,j) and a rate of change of the weight according to and the distance between a reference pixel and a current block, and may transmit the weight information of wᵢₙₜₑᵣ(i,j) and wᵢₙₜᵣₐ(i,j) applied in a unit of pixel to the decoder.

As an example of the weight in a vertical mode in Table 2, when the values of wᵢₙₜₑᵣ(i,j) and wᵢₙₜᵣₐ(i,j) are 0.75 and 0.25, respectively, the encoder may transmit initial weight information (0.75 and 0.25) and may transmit the rate of change information that the value of wᵢₙₜᵣₐ(i,j) decreases by 0.02 and the value of wᵢₙₜₑᵣ(i,j) increases by 0.02 whenever the vertical direction coordinate (i.e., j value) increases by 1, and may transmit the weight information applied in a unit of pixel to the decoder.

As an example of the weight in a vertical mode in Table 2, when the values of wᵢₙₜₑᵣ(i,j) and wᵢₙₜᵣₐ(i,j) are 0.75 and 0.25, respectively, the encoder may transmit initial weight information (0.75 and 0.25) and may transmit the rate of change information that the value of wᵢₙₜᵣₐ(i,j) decreases by 0.02 and the value of wᵢₙₜₑᵣ(i,j) increases by 0.02 whenever the vertical direction coordinate increases by 1, and may transmit the weight information applied in a unit of pixel to the decoder.

3) The decoder may derive (induce) a weight value from the weight information. The weight value may be derived (induced) by the following method.

In the case that the encoder transmits the determined weight value to the decoder without any change, the decoder may use the weight value transmitted from the encoder without any change.

In the case that the encoder and the decoder store the weight value in a table and the encoder transmits a table index, the decoder may use the weight value indicated by the table index.

In the case that the encoder transmits initial values (values when i=0 and j=0) of wᵢₙₜₑᵣ(i,j) and wᵢₙₜᵣₐ(i,j) and a rate of change of the weight according to and the distance between a reference pixel and a current block, the decoder may derive a weight value applied in a unit of pixel by using the received initial value information and the rate of change information.

(2) Implicit determination method

An encoder and a decoder store weight values in a table in advance, and the decoder may determine the same weight value implicitly as that of the encoder and use it although the encoder does not signal the weight value or a table index.

For example, according to an inter-prediction mode and/or an intra-prediction mode, the values of wᵢₙₜₑᵣ(i,j) and wᵢₙₜᵣₐ(i,j) may be determined from the predetermined weight value table.

That is, the encoder and the decoder may derive a weight value from the weight table stored according to an inter-prediction mode in advance, and may derive a weight value from the weight value table stored according to an intra-prediction mode in advance. In addition, a weight value may be determined according to the inter-prediction mode and the intra-prediction mode, and may derive a weight value from the weight value table stored in advance.

(3) In addition, a certain block, a slice or a picture may derive a weight value by using the explicit determination method in a unit of block, slice or picture, and a certain block, a slice or a picture may derive a weight value by using the implicit determination method.

Definition of a Syntax Element

Since the joint prediction between images and within an image is a new prediction method different from the existing prediction between images and the prediction within an image, the information may be added to the existing syntax.

Among the inter-prediction, the intra-prediction and the Joint inter-intra prediction, the information indicating a prediction mode applied to a current block may be defined. For example, pred_mode may be defined.

Two methods including a method of transmitting an intra-prediction mode and a method of not transmitting an intra-prediction mode are available in the Joint prediction within an image, and accordingly, the respective syntax elements may be defined.

First, an embodiment of newly defining the existing pred_mode_flag syntax element as pred_mode is described. The pred_mode syntax is exemplified through Table 3.

TABLE 3

| pred_mode | Syntax value |
|---|---|
| Inter-prediction | 0 |
| Intra-prediction | 10 |
| Joint inter-intra prediction | 11 |

Referring to the example of Table 3, a prediction mode of a current process block may be derived by parsing pred_mode syntax element. In the case that pred_mode syntax element value is zero, this means it is decoded with an inter-prediction mode. In the case that pred_mode syntax element value is 10, this means it is decoded with an intra-prediction mode. In the case that pred_mode syntax element value is 11, this means it is decoded with a Joint inter-intra prediction mode.

Table 4 exemplifies a part of syntax of a coding unit label for a Joint inter-intra prediction mode in the case that an intra-prediction mode is not transmitted.

TABLE 4

| coding_unit( x0, y0, log2CbSize ) { | Descriptor |
|---|---|
| if( transquant_bypass_enabled_flag ) | |
| cu_transquant_bypass_flag | ae(v) |
| if( slice_type != I) | |
| cu_skip_flag[ x0 ][ y0 ] | ae(v) |
| nCbS = ( 1 << log2CbSize) | |
| if( cu_skip_flag[ x0 ][ y0 ] ) | |
| prediction_unit( x0, y0, nCbS, nCbS) | |
| else { | |
| if( slice_type != I ) | |
| pred_mode | ae(v) |
| if( CuPredMode[ x0 ][ y0] != MODE_INTRA \|\| | |
| log2CbSize = = | |
| MinCbLog2SizeY ) | |
| part_mode | ae(v) |
| if( CuPredMode[ x0 ][ y0 ] = = MODE_INTRA ) { | |
| if( PartMode = = PART_2Nx2N && | |
| pcm_enabled_flag && | |
| log2CbSize >= Log2MinIpcmCbSizeY && | |
| log2CbSize <= Log2MaxIpcmCbSizeY ) | |
| pcm_flag[ x0 ][ y0 ] | ae(v) |
| if( pcm_flag[ x0 ][ y0 ] ) { | |
| while( !byte_aligned( ) ) | |
| pcm_alignment_zero_bit | f(1) |
| pcm_sample( x0, y0, log2CbSize) | |
| } else { | |
| pbOffset = ( PartMode = = PART_NxN ) ? | |
| ( nCbS / 2) : | |
| nCbS | |
| for( j = 0; j < nCbS; j = j + pbOffset ) | |
| for( i = 0; i < nCbS; i = i + pbOffset ) | |
| prev_intra_luma_pred_flag[ x0 + i ][ y0 + j ] | ae(v) |
| for( j = 0; j < nCbS; j = j + pbOffset ) | |
| for( i = 0; i < nCbS; i = i + pbOffset ) | |
| if( prev_intra_luma_pred_flag[ x0 + i ][ y0 + j ] ) | |
| mpm_idx[ x0 + i ][ y0 + j ] | ae(v) |
| else | |
| rem_intra_luma_pred_mode[ x0 + i ][ y0 + j ] | ae(v) |
| intra_chroma_pred_mode[ x0 ][ y0 ] | ae(v) |
| } | |
| } else if (CuPredMode[ x0 ][ y0 ] = = MODE_INTER ){ | |
| if( PartMode = = PART_2Nx2N ) | |
| prediction_unit( x0, y0, nCbS, nCbS) | |
| else if( PartMode = = PART_2NxN ) { | |
| prediction_unit( x0, y0, nCbS, nCbS / 2) | |
| prediction_unit( x0, y0 + ( nCbS / 2), nCbS, | |
| nCbS / 2) | |
| } else if( PartMode = = PART_Nx2N ) { | |
| prediction_unit( x0, y0, nCbS / 2, nCbS) | |
| prediction_unit( x0 + ( nCbS / 2), y0, nCbS / | |
| 2, nCbS) | |
| } else if( PartMode = = PART_2NxnU ) { | |
| prediction_unit( x0, y0, nCbS, nCbS / 4 ) | |
| prediction_unit( x0, y0 + ( nCbS /4 ), nCbS, | |
| nCbS * 3 / 4 ) | |
| } else if( PartMode = = PART_2NxnD) { | |
| prediction_unit( x0, y0, nCbS, nCbS * 3 / 4) | |
| prediction_unit( x0, y0 + ( nCbS * 3 / 4), nCbS, | |
| nCbS / 4) | |
| } else if( PartMode = = PART_nLx2N ) { | |
| prediction_unit( x0, y0, nCbS /4, nCbS) | |
| prediction_unit( x0 + ( nCbS / 4), y0, nCbS * | |
| 3 / 4, nCbS) | |
| } else if( PartMode = = PART_nRx2N ) { | |
| prediction_unit( x0, y0, nCbS * 3 /4, nCbS) | |
| prediction_unit( x0 + ( nCbS * 3 / 4 ), y0, | |
| nCbS /4, nCbS) | |
| } else { /* PART_NxN */ | |
| prediction_unit( x0, y0, nCbS / 2, nCbS / 2) | |
| prediction_unit( x0 + ( nCbS / 2), y0, nCbS / | |
| 2, nCbS / 2) | |
| prediction_unit( x0, y0 + ( nCbS / 2 ), | |
| nCbS / 2, nCbS / 2) | |
| prediction_unit( x0 + ( nCbS / 2), y0 + ( nCbS / 2 ), | |
| nCbS / 2, nCbS / 2) | |
| } | |
| } else { | |
| if( PartMode = = PART_2Nx2N ) | |
| prediction_unit( x0, y0, nCbS, nCbS) | |
| else if( PartMode = = PART_2NxN ) { | |
| prediction_unit( x0, y0, nCbS, nCbS / 2) | |
| prediction_unit( x0, y0 + ( nCbS / 2 ), | |
| nCbS, nCbS / 2) | |
| } else if( PartMode = = PART_Nx2N ) 1{ | |
| prediction_unit( x0, y0, nCbS / 2, nCbS) | |
| prediction_unit( x0 + ( nCbS / 2), y0, | |
| nCbS / 2, nCbS) | |
| } else if( PartMode = = PART_2NxnU ) { | |
| prediction_unit( x0, y0, nCbS, nCbS / 4 ) | |
| prediction_unit( x0, y0 + ( nCbS /4 ), nCbS, | |
| nCbS * 3 / 4 ) | |
| } else if( PartMode = = PART_2NxnD ) 1 | |
| prediction_unit( x0, y0, nCbS, nCbS * 3 / 4) | |
| prediction_unit( x0, y0 + ( nCbS * 3 / 4), nCbS, | |
| nCbS / 4) | |
| } else if( PartMode = = PART_nLx2N ) { | |
| prediction_unit( x0, y0, nCbS /4, nCbS) | |
| prediction_unit( x0 + ( nCbS / 4), y0, nCbS * | |
| 3 / 4, nCbS) | |
| } else if( PartMode = = PART_nRx2N ) { | |
| prediction_unit( x0, y0, nCbS * 3 /4, nCbS) | |
| prediction_unit( x0 + ( nCbS * 3 / 4 ), y0, | |
| nCbS /4, nCbS) | |
| } else 1 /* PART_NxN */ | |
| prediction_unit( x0, y0, nCbS / 2, nCbS / 2) | |
| prediction_unit( x0 +( nCbS / 2), y0, nCbS / | |
| 2, nCbS / 2) | |
| prediction_unit( x0, y0 + ( nCbS / 2 ), nCbS / | |
| 2, nCbS / 2) | |
| prediction_unit( x0 + ( nCbS / 2), y0 + ( nCbS / 2 ), | |
| nCbS / 2,nCbS / 2) | |
| } | |
| } | |
| if( CuPredMode[ x0 ][ y0 ] != MODE_INTRA && | |
| !( PartMode = = PART_2Nx2N && | |
| merge_flag[ x0 ][ y0 ] ) ) | |
| rqt_root_cbf | ae(v) |
| if( rqt_root_cbf ) { | |
| MaxTrafoDepth = ( CuPredMode[ x0 ][ y0 ] = = | |
| MODE_INTRA ? | |
| ( max_transform_hierarchy_depth_intra + | |
| IntraSplitFlag ) : | |
| max_transform_hierarchy_depth_inter ) | |
| transform_tree( x0, y0, x0, y0, log2CbSize, 0, 0) | |
| } | |
| } | |
| } | |
| } | |

Referring to Table 4, a decoding process for a coding unit (or coding block) is described.

if(transquant_bypass_enabled_flag): When a decoding process ‘coding_unit(x0, y0, log 2CbSize)’ for a coding unit (or coding block) is called (herein, x0 and y0 represents a relative position of a top-left sample of a current coding unit from a top-left sample of a current picture, and log 2CbSize represents a size of the current coding unit), a decoder determines whether ‘cu_transquant_bypass_flag’ is existed first.

Here, when the value of ‘transquant_bypass_enabled_flag’ is 1, it means that ‘cu_transquant_bypass_flag’ is existed.

cu_transquant_bypass_flag: When ‘cu_transquant_bypass_flag’ is existed, the decoder parses ‘cu_transquant_bypass_flag’.

In the case that ‘cu_transquant_bypass_flag’ value is 1, the scaling and transform process and the in-loop filter process may be skipped.

if(slice_type !=I): The decoder determines whether a slice type of the current coding unit is not a slice type.

cu_skip_flag[x0][y0]: In the case that the slice type of the current coding unit is not a slice, the decoder parses ‘cu_skip_flag[x0][y0]’.

Here, ‘cu_skip_flag[x0][y0]’ may represent whether the current coding unit is in a skip mode. That is, in the case that ‘cu_skip_flag[x0][y0]’ is 1, this may indicate that an additional syntax element except the index information for merge is not parsed in a coding unit syntax.

nCbS=(1<<log 2CbSize): A variable nCbs is set to ‘1 <<log 2CbSize’ value.

if(cu_skip_flag[x0][y0]): The decoder determines whether the current coding unit is in the skip mode.

prediction_unit(x0, y0, nCbS, nCbS): In the case that the current coding unit is in the skip mode, the decoding process ‘prediction_unit(x0, y0, nCbS, nCbS)’ for a prediction unit (or prediction block) is called, and an additional syntax element is not signaled.

if(slice_type !=I): On the contrary, in the case that the current coding unit is not in the skip mode, the decoder determines whether the current slice type is a slice.

pred_mode: In the current slice type is not a slice; the decoder parses ‘pred_mode’.

As described above, the syntax for deriving a prediction mode of the current coding unit may be defined as ‘pred_mode’. Here, in the case that Pred_mode syntax element value is zero, this means it is encoded in an inter-prediction mode. In the case that Pred_mode syntax element value is 10, this means it is encoded in an intra-prediction mode. In the case that Pred_mode syntax element value is 11, this means it is encoded in a Joint inter-intra prediction mode.

if(CuPredMode[x0][y0]!=MODE_INTRA||log 2CbSize==MinCb Log 2SizeY): It is determined whether a prediction mode of the current coding unit is an intra mode or not, and whether a size (log 2CbSize) of the current coding unit is the same as a size (MinCb Log 2SizeY) of a minimum coding unit.

In the case that the current coding unit is coded in the intra-prediction mode while a size of the current coding unit is not a size of the minimum coding unit, since a slit mode is 2N×2N always, ‘part_mode’ syntax element is not required to be parsed.

part_mode: In the case that the prediction mode of the current coding unit is not the intra mode or a size (log 2CbSize) of the current coding unit is the same as a size (MinCb Log 2SizeY) of the minimum coding unit, ‘part_mode’ syntax element is parsed.

Here, in the case that the current coding unit is coded in an intra-prediction mode, when ‘part_mode’ has values of 0 and 1, which may mean PART_2N×2N and PART_N×N, respectively. In the case that the current coding unit is coded in an inter-prediction mode, a value of ‘part_mode’ may be sequentially allocated to PART_2N×2N(0), PART_2N×N(1), PART_N×2N(2), PART_{—N×N(}3), PART_2N×nU(4), PART_2N×nD(5), PART_nL×2N(6) and PART_nR×2N(7).

In the case that the current coding unit is coded in an inter-prediction mode, in the same way as the case of being coded in the inter mode, a value of ‘part_mode’ may be sequentially allocated to PART_2N×2N(0), PART_2N×N(1), PART_N×2N(2), PART_N×N(3), PART_2N×nU(4), PART_2N×nD(5), PART_{—nL×}2N(6) and PART_nR×2N(7).

if(CuPredMode[x0][y0]==MODE_INTRA): The decoder determines whether the prediction mode of the current coding unit is the intra mode.

if(PartMode==PART_2N×2N && pcm_enabled_flag && log 2CbSize>=Log 2MinIpcmCbSizeY && log 2CbSize<=Log 2MaxIpcmCbSizeY): The decoder determines whether a partition mode of the current coding unit is PART_2N×2N, a current coding block is in PCM mode, a size of the current coding unit is equal to or greater than Log 2MinIpcmCbSizeY and a size of current coding unit is equal to or smaller than Log 2MaxIpcmCbSizeY.

pcm_flag[x0][y0]: In the case that a partition mode of the current coding unit is PART_2N×2N, a current coding block is in PCM mode, a size of the current coding unit is equal to or greater than Log 2MinIpcmCbSizeY and a size of current coding unit is equal to or smaller than Log 2MaxIpcmCbSizeY, the decoder parses ‘pcm_flag[x0][y0]’.

Here, in the case that ‘pcm_flag[x0][y0]’ value is 1, this means that a coding unit of a luminance element has ‘pcm_sample( )’ syntax in a coordinate (x0, y0), and that ‘transform_tree( )’ syntax is not existed. In the case that ‘pcm_flag[x0][y0]’ value is 1, this means that a coding unit of a luminance element does not have ‘pcm_sample( )’ syntax in a coordinate (x0, y0).

if(pcm_flag[x0][y0]): The decoder determines whether the current coding unit is in PCM mode.

while(!byte_aligned( )): In the case that the current coding unit is in PCM mode, the decoder determines whether a current position is in a boundary of a byte in a bit stream.

pcm_alignment_zero_bit: In the case that a current position is not in a boundary of a byte in a bit stream, the decoder parses pcm_alignment_zero_bit.

Here, a value of pcm_alignment_zero_bit is zero.

pcm_sample(x0, y0, log 2CbSize): In addition the decoder calls pcm_sample(x0, y0, log 2CbSize) syntax in the case that the current coding unit is in PCM mode.

The ‘pcm_sample( )’ syntax represents a luminance element or a chrominance element value which is coded in a raster scan order in the current coding unit. The PCM sample bit depth of the luminance element or the chrominance element of the current coding unit may be represented by using a bit number.

pbOffset=(PartMode==PART_N×N)?(nCbS/2): nCbS: In the case that the current coding unit is not coded in PCM mode, a variable pbOffset value is set to nCbS/2 value when a partition mode (PartMode) of the current coding unit is PART_N×N and set to nCbS value when a partition mode (PartMode) of the current coding unit is PART_2N×2N.

for(j=0; j<nCbS; j=j+pbOffset)

for(i=0; i <nCbS; i=i+pbOffset)

prev_intra_luma_pred_flag[x0+i][y0+j ]: The decoder parses prev_intra_luma_pred_flag[x0+i][y0+j ] in a unit of prediction unit.

For example, in the case that a partition mode (PartMode) of the current coding unit is PART_2N×2N, pbOffset value is set to nCbS value. In this case, only prev_intra_luma_pred_flag[x0][y0] is parsed.

In the case that a partition mode (PartMode) of the current coding unit is PART_N×N, pbOffset value is set to nCbS/2 value. In this case, prev_intra_luma_pred_flag[x0][y0], prev_intra_luma_pred_flag[x0+nCbS/2][y0], prev_intra_luma_pred_flag[x0][y0+nCbS/2], prev_intra_luma_pred_flag[x0+nCbS/2][y0+nCbS/2] are parsed.

That is, prev_intra_luma_pred_flag is parsed in a unit of prediction unit. In the case that prev_intra_luma_pred_flag value is 1, this means that the intra-prediction mode of the current prediction unit is included in Most Probable Mode (MPM), and in the case that prev_intra_luma_pred_flag value is 0, this means that the intra-prediction mode of the current prediction unit is not included in Most Probable Mode (MPM).

for(j=0; j<nCbS; j=j+pbOffset)

for(i=0; i<nCbS; i=i+pbOffset)

if(prev_intra_luma_pred_flag[x0+i][y0+j]): As described above, the decoder determines whether the intra-prediction mode of the current prediction unit is included in Most Probable Mode (MPM) in a unit of prediction unit.

mpm_idx[x0+i][y0+j ]: In the case that the intra-prediction mode of the current prediction unit is included in Most Probable Mode (MPM), MPM index (mpm_idx) is parsed.

Here, in the case that MPM index (mpm_idx) is 0, 1 and 2, this represents Intra_Planar, Intra_DC and Intra_Vertical modes, respectively.

rem_intra_luma_pred_mode[x0+i][y0+j ]: In the case that the intra-prediction mode of the current prediction unit is not included in Most Probable Mode (MPM), rem_intra_luma_pred_mode is parsed.

That is, the intra-prediction mode for the current prediction unit may be derived by decoding rem_intra_luma_pred_mode through a fixed 5 bits binary table for remaining 32 modes that are not included in the Most Probable Mode (MPM).

intra_chroma_pred_mode[x0][y0]: In the case that a prediction mode of the current coding unit is the intra mode and does not correspond to PCM mode, intra_chroma_pred_mode syntax element is parsed, which represents a prediction mode of a chrominance element in a unit of prediction unit.

else if (CuPredMode[x0][y0]==MODE_INTER): The decoder determines whether a prediction mode of the current coding unit is an inter mode.

In the case that a prediction mode of the current coding unit is not the intra mode, although it is determined to be the inter mode, since a Joint inter-intra prediction mode of the present invention is added, the case of inter mode may be separately limited by using ‘else if’ syntax.

if(PartMode==PART_2N×2N): In the case that a prediction mode of the current coding unit is the inter mode, the decoder determines whether a partition mode (PartMode) of the current coding unit is PART_2N×2N.

prediction_unit(x0, y0, nCbS, nCbS): In the case that a partition mode (PartMode) of the current coding unit is PART_2N×2N, a decoding process prediction_unit(x0, y0, nCbS, nCbS) for a prediction unit (or prediction block) is called.

else if(PartMode==PART_2N×N): The decoder determines whether a partition mode (PartMode) of the current coding unit is PART_2N×N.

prediction_unit(x0, y0, nCbS, nCbS/2)

prediction_unit(x0, y0+(nCbS/2), nCbS, nCbS/2): In the case that a partition mode (PartMode) of the current coding unit is PART_2N×N, a decoding process prediction_unit(x0, y0, nCbS, nCbS/2) and prediction_unit(x0, y0+(nCbS/2), nCbS, nCbS/2) for a prediction unit (or prediction block) are called.

else if(PartMode==PART_N×2N): The decoder determines whether a partition mode (PartMode) of the current coding unit is PART_N×2N.

prediction_unit(x0, y0, nCbS/2, nCbS)

prediction_unit(x0+(nCbS/2), y0, nCbS/2, nCbS): In the case that a partition mode (PartMode) of the current coding unit is PART_N×2N, a decoding process prediction_unit(x0, y0, nCbS/2, nCbS) and prediction_unit(x0+(nCbS/2), y0, nCbS/2, nCbS) for a prediction unit (or prediction block) are called.

else if(PartMode==PART_2N×nU): The decoder determines whether a partition mode (PartMode) of the current coding unit is PART_2N×nU.

prediction_unit(x0, y0, nCbS, nCbS/4)

prediction_unit(x0, y0+(nCbS/4), nCbS, nCbS*3/4): In the case that a partition mode (PartMode) of the current coding unit is PART_2NxnU, a decoding process prediction_unit(x0, y0, nCbS, nCbS/4) and prediction_unit(x0, y0+(nCbS/4), nCbS, nCbS*3/4) for a prediction unit (or prediction block) are called.

else if(PartMode==PART_2N×nD): The decoder determines whether a partition mode (PartMode) of the current coding unit is PART_2N×nD.

prediction_unit(x0, y0, nCbS, nCbS*3/4)

prediction_unit(x0, y0+(nCbS*3/4), nCbS, nCbS/4): In the case that a partition mode (PartMode) of the current coding unit is PART_2N×nD, a decoding process prediction_unit(x0, y0, nCbS, nCbS*3/4) and prediction_unit(x0, y0+(nCbS*3/4), nCbS, nCbS/4) for a prediction unit (or prediction block) are called.

else if(PartMode==PART_nL×2N): The decoder determines whether a partition mode (PartMode) of the current coding unit is PART_nL×2N.

prediction_unit(x0, y0, nCbS/4, nCbS)

prediction_unit(x0+(nCbS/4), y0, nCbS*3/4, nCbS): In the case that a partition mode (PartMode) of the current coding unit is PART_{—nL×}2N, a decoding process prediction_unit(x0, y0, nCbS/4, nCbS) and prediction_unit(x0+(nCbS/4), y0, nCbS*3/4, nCbS) for a prediction unit (or prediction block) are called.

else if(PartMode==PART_nR×2N): The decoder determines whether a partition mode (PartMode) of the current coding unit is PART_nR×2N.

prediction_unit(x0, y0, nCbS*3/4, nCbS)

prediction_unit(x0+(nCbS*3/4), y0, nCbS/4, nCbS): In the case that a partition mode (PartMode) of the current coding unit is PART_nR×2N, a decoding process prediction_unit(x0, y0, nCbS*3/4, nCbS) and prediction_unit(x0+(nCbS*3/4), y0, nCbS/4, nCbS) for a prediction unit (or prediction block) are called.

prediction_unit(x0, y0, nCbS/2, nCbS/2)

prediction_unit(x0+(nCbS/2), y0, nCbS/2, nCbS/2)

prediction_unit(x0, y0+(nCbS/2), nCbS/2, nCbS/2)

prediction_unit(x0+(nCbS/2), y0+(nCbS/2), nCbS/2, nCbS/2): In the case that a partition mode (PartMode) of the current coding unit is PART_N×N, a decoding process prediction_unit(x0, y0, nCbS/2, nCbS/2), prediction_unit(x0+(nCbS/2), y0, nCbS/2, nCbS/2), prediction_unit(x0, y0+(nCbS/2), nCbS/2, nCbS/2) and prediction_unit(x0+(nCbS/2), y0+(nCbS/2), nCbS/2, nCbS/2) for a prediction unit (or prediction block) are called.

if(PartMode==PART_2N×2N): In the case that a prediction mode of the current coding unit does not correspond to the intra mode and also does not correspond to the inter mode, the decoder determines whether a partition mode (PartMode) of the current coding unit is PART_2N×2N.

Even in the case of the Joint inter-intra prediction mode, in the same way in the inter mode, a decoding process prediction_unit for a prediction unit (or prediction block) are called.

prediction_unit(x0, y0, nCbS, nCbS): In the case that a prediction mode of the current coding unit is the Joint inter-intra prediction mode and a partition mode (PartMode) is PART_2N×2N, a decoding process prediction_unit(x0, y0, nCbS, nCbS) for a prediction unit (or prediction block) are called.

else if(PartMode==PART_2N×N): The decoder determines whether a partition mode (PartMode) of the current coding unit is PART_2N×N.

prediction_unit(x0, y0, nCbS, nCbS/2)

prediction_unit(x0, y0+(nCbS/2), nCbS, nCbS/2): In the case that a prediction mode of the current coding unit is the Joint inter-intra prediction mode and a partition mode (PartMode) is PART_2N×N, a decoding process prediction_unit(x0, y0, nCbS, nCbS/2) and prediction_unit(x0, y0+(nCbS/2), nCbS, nCbS/2) for a prediction unit (or prediction block) are called.

else if(PartMode==PART_N×2N): The decoder determines whether a partition mode (PartMode) of the current coding unit is PART_N×2N.

prediction_unit(x0, y0, nCbS/2, nCbS)

prediction_unit(x0+(nCbS/2), y0, nCbS/2, nCbS): In the case that a prediction mode of the current coding unit is the Joint inter-intra prediction mode and a partition mode (PartMode) is PART_N×2N, a decoding process prediction_unit(x0, y0, nCbS/2, nCbS) and prediction_unit(x0+(nCbS/2), y0, nCbS/2, nCbS) for a prediction unit (or prediction block) are called.

else if(PartMode==PART_2N×nU): The decoder determines whether a partition mode (PartMode) of the current coding unit is PART_2N×nU.

prediction_unit(x0, y0, nCbS, nCbS/4)

prediction_unit(x0, y0+(nCbS/4), nCbS, nCbS*3/4): In the case that a prediction mode of the current coding unit is the Joint inter-intra prediction mode and a partition mode (PartMode) is PART_2N×nU, a decoding process prediction_unit(x0, y0, nCbS, nCbS/4) and prediction_{—unit(x}0, y0+(nCbS/4), nCbS, nCbS*3/4) for a prediction unit (or prediction block) are called.

else if(PartMode==PART_2N×nD): The decoder determines whether a partition mode (PartMode) of the current coding unit is PART_2N×nD.

prediction_{—unit(x}0, y0, nCbS, nCbS*3/4)

prediction_{—unit(x}0, y0+(nCbS*3/4), nCbS, nCbS/4): In the case that a prediction mode of the current coding unit is the Joint inter-intra prediction mode and a partition mode (PartMode) is PART_2N×nD, a decoding process prediction_{—unit(x}0, y0, nCbS, nCbS*3/4) and prediction_{—unit(x}0, y0+(nCbS*3/4), nCbS, nCbS/4) for a prediction unit (or prediction block) are called.

else if(PartMode==PART_{—nL×}2N): The decoder determines whether a partition mode (PartMode) of the current coding unit is PART_{—nL×}2N.

prediction_{—unit(x}0, y0, nCbS/4, nCbS)

prediction_{—unit(x}0+(nCbS/4), y0, nCbS*3/4, nCbS): In the case that a prediction mode of the current coding unit is the Joint inter-intra prediction mode and a partition mode (PartMode) is PART_{—nL×}2N, a decoding process prediction_{—unit(x}0, y0, nCbS/4, nCbS) and prediction_{—unit(x}0+(nCbS/4), y0, nCbS*3/4, nCbS) for a prediction unit (or prediction block) are called.

else if(PartMode==PART_{—nR×}2N): The decoder determines whether a partition mode (PartMode) of the current coding unit is PART_{—nR×}2N.

prediction_{—unit(x}0, y0, nCbS*3/4, nCbS)

prediction_{—unit(x}0+(nCbS*3/4), y0, nCbS/4, nCbS): In the case that a prediction mode of the current coding unit is the Joint inter-intra prediction mode and a partition mode (PartMode) is PART_{—nL×}2N, a decoding process prediction_{—unit(x}0, y0, nCbS*3/4, nCbS) and prediction_{—unit(x}0+(nCbS*3/4), y0, nCbS/4, nCbS) for a prediction unit (or prediction block) are called.

prediction_{—unit(x}0, y0, nCbS/2, nCbS/2)

prediction_{—unit(x}0+(nCbS/2), y0, nCbS/2, nCbS/2)

prediction_{—unit(x}0, y0+(nCbS/2), nCbS/2, nCbS/2)

prediction_{—unit(x}0+(nCbS/2), y0+(nCbS/2), nCbS/2, nCbS/2): In the case that a prediction mode of the current coding unit is the Joint inter-intra prediction mode and a partition mode (PartMode) is PART_N×N, a decoding process prediction_{—unit(x}0, y0, nCbS/2, nCbS/2), prediction_{—unit(x}0+(nCbS/2), y0, nCbS/2, nCbS/2), prediction_{—unit(x}0, y0+(nCbS/2), nCbS/2, nCbS/2) and prediction_{—unit(x}0+(nCbS/2), y0+(nCbS/2), nCbS/2, nCbS/2) for a prediction unit (or prediction block) are called.

if(CuPredMode[x0][y0]!=MODE_INTRA && !(PartMode==PART_2N×2N && merge_flag[x0][y0])): The decoder determines whether a prediction mode of the current coding unit is not the intra mode, and the current coding unit is in the merge mode as well as a partition mode is not PART_2N×2N.

rqt_root_cbf: In the case that a prediction mode of the current coding unit is not the intra mode, and the current coding unit is in the merge mode as well as a partition mode is not PART_2N×2N, the decoder parses rqt_root_cbf.

The case that rqt_root_cbf value is 1 means that there is a transform tree syntax (transform_tree( )syntax) for the current coding unit, and the case that rqt_root_cbf value is zero means that there is no transform tree syntax (transform_tree( )syntax).

if(rqt_root_cbf): The decoder determines whether the rqt_root_cbf syntax element value is 1, that is, determines whether to call the transform tree syntax (transform_tree( ) syntax).

MaxTrafoDepth=(CuPredMode[x0][y0]==MODE_INTRA? max_transform_hierarchy_depth_intra IntraSplitFlag max_transform_hierarchy_depth_inter): As variable MaxTrafoDepth value, in the case that a current prediction mode is the intra mode, the decoder setup max_transform_hierarchy_depth_intra +IntraSplitFlag value, and in the case that a current prediction mode is the inter mode, the decoder setup max_transform_hierarchy_depth_inter value.

Here, the max_transform_hierarchy_depth_intra value represents value indicates a maximum layer depth for a transform block of a current coding block in the intra-prediction mode, and the max_transform_hierarchy_depth_inter indicates a maximum layer depth for a transform block of a current coding block in the inter-prediction mode. The case that IntraSplitFlag value is zero represents the case that a partition mode is PART_2N×2N in the intra mode, and the case that IntraSplitFlag value is 1 represents the case that a partition mode is PART_N×N in the intra mode.

Table 5 exemplifies a part of syntax in a coding unit level for the joint inter-intra prediction mode, in the case of transmitting an intra-prediction mode.

TABLE 5

| | De- |
|---|---|
| | scrip- |
| coding_unit( x0, y0, log2CbSize) { | tor |
| if( transquant_bypass_enabled_flag ) | |
| cu_transquant_bypass_flag | ae(v) |
| if( slice_type != I) | |
| cu_skip_flag[ x0 ][ y0 ] | ae(v) |
| nCbS = ( 1 << log2CbSize) | |
| if( cu_skip_flag[ x0 ][ y0 ] ) | |
| prediction_unit( x0, y0, nCbS, nCbS) | |
| else { | |
| if( slice_type != I) | |
| pred_mode | ae(v) |
| if( CuPredMode[ x0 ][ y0 ] != MODE_INTRA \| \| log2CbSize | |
| = = | |
| MinCbLog2SizeY ) | |
| part_mode | ae(v) |
| if( CuPredMode[ x0 ][ y0 ] = = MODE_INTRA ) { | |
| if( PartMode = = PART_2Nx2N && pcm_enabled_flag && | |
| log2CbSize >= Log2MinIpcmCbSizeY && | |
| log2CbSize <= Log2MaxIpcmCbSizeY ) | |
| pcm_flag[ x0 ][ y0 ] | ae(v) |
| if( pcm_flag[ x0 ][ y0 ] ) { | |
| while( !byte_aligned( ) ) | |
| pcm_alignment_zero_bit | f(1) |
| pcm_sample( x0, y0, log2CbSize) | |
| } else { | |
| pbOffset = ( PartMode = = PART_NxN ) ? ( nCbS / 2 ) : | |
| nCbS | |
| for( j = 0; j < nCbS; j = j + pbOffset ) | |
| for( i = 0; i < nCbS; i = i + pbOffset ) | |
| prev_intra_luma_pred_flag[ x0 + i ][ y0 + j ] | ae(v) |
| for( j = 0; j < nCbS; j = j + pbOffset ) | |
| for( i = 0; i < nCbS; i = i + pbOffset ) | |
| if( prev_intra_luma_pred_flag[ x0 + i ][ y0 + j] | |
| mpm_idx[ x0 + i][ y0 + j] | ae(v) |
| else | |
| rem_intra_luma_pred_mode[ x0 + i ][ y0 + j ] | ae(v) |
| intra_chroma_pred_mode[ x0 ][ y0 ] | ae(v) |
| } | |
| } else if (CuPredMode[ x0 ][ y0 ] = = MODE_INTER ) | |
| if( PartMode = = PART_2Nx2N ) | |
| prediction_unit( x0, y0, nCbS, nCbS) | |
| else if( PartMode = = PART_2NxN ) { | |
| prediction_unit( x0, y0, nCbS, nCbS / 2) | |
| prediction_unit( x0, y0 + ( nCbS / 2), nCbS, nCbS / 2) | |
| } else if( PartMode = = PART_Nx2N ) { | |
| prediction_unit( x0, y0, nCbS / 2, nCbS) | |
| prediction_unit( x0 + ( nCbS / 2), y0, nCbS / 2, nCbS) | |
| } else if( PartMode + + PART_2NxnU ) { | |
| prediction_unit( x0, y0, nCbS, nCbS / 4 ) | |
| prediction_unit( x0, y0 + ( nCbS / 4 ), nCbS, nCbS * | |
| 3 / 4) | |
| } else if( PartMode = = PART_2NxnD ) { | |
| prediction_unit( x0, y0, nCbS, nCbS * 3 / 4) | |
| prediction_unit( x0, y0 + ( nCbS * 3 / 4), nCbS, | |
| nCbS / 4) | |
| } else if( PartMode + + PART_nLx2N ) { | |
| prediction_unit( x0, y0, nCbS /4, nCbS) | |
| prediction_unit( x0 + ( nCbS / 4), y0, nCbS * | |
| 3 / 4, nCbS) | |
| } else if( PartMode = = PART_nRx2N ) { | |
| prediction_unit( x0, y0, nCbS * 3 /4, nCbS) | |
| prediction_unit( x0 + ( nCbS * 3 / 4 ), y0, nCbS /4, | |
| nCbS) | |
| } else { /* PART_NxN */ | |
| prediction_unit( x0, y0, nCbS / 2, nCbS / 2) | |
| prediction_unit( x0 + ( nCbS / 2), y0, nCbS / 2, | |
| nCbS / 2) | |
| prediction_unit( x0, y0 + ( nCbS / 2 ), nCbS / 2, | |
| nCbS / 2) | |
| prediction_unit( x0 + ( nCbS / 2), y0 + ( nCbS / 2 ), | |
| nCbS /2, nCbS / 2) | |
| } | |
| } else { | |
| if( PartMode = = PART_2Nx2N ) | |
| prediction_unit( x0, y0, nCbS, nCbS) | |
| else if( PartMode = = PART_2NxN ) 1 | |
| prediction_unit( x0, y0, nCbS, nCbS / 2) | |
| prediction_unit( x0, y0 + ( nCbS / 2 ), nCbS, nCbS / 2) | |
| } else if( PartMode = = PART_Nx2N ) 1 | |
| prediction_unit( x0, y0, nCbS / 2, nCbS) | |
| prediction_unit( x0 + ( nCbS / 2), y0, nCbS / 2, nCbS) | |
| } else if( PartMode + + PART_2NxnU ) { | |
| prediction_unit( x0, y0, nCbS, nCbS / 4 ) | |
| prediction_unit( x0, y0 + ( nCbS /4 ), nCbS, | |
| nCbS * 3 / 4 ) | |
| } else if( PartMode + + PART_2NxnD ) { | |
| prediction_unit( x0, y0, nCbS, nCbS * 3 / 4) | |
| prediction_unit( x0, y0 + ( nCbS * 3 / 4), nCbS, | |
| nCbS / 4) | |
| } else if( PartMode + + PART_nLx2N ) { | |
| prediction_unit( x0, y0, nCbS /4, nCbS) | |
| prediction_unit( x0 + ( nCbS / 4), y0, nCbS * 3 / 4, | |
| nCbS) | |
| } else if( PartMode + + PART_nRx2N ) { | |
| prediction_unit( x0, y0, nCbS * 3 /4, nCbS) | |
| prediction_unit( x0 + ( nCbS * 3 / 4 ), y0, nCbS /4, | |
| nCbS) | |
| } else { /* PART_NxN */ | |
| prediction_unit( x0, y0, nCbS / 2, nCbS / 2) | |
| prediction_unit( x0 + ( nCbS / 2), y0, nCbS / 2, | |
| nCbS / 2) | |
| prediction_unit( x0, y0 + ( nCbS / 2 ), nCbS / 2, | |
| nCbS / 2) | |
| prediction_unit( x0 + ( nCbS / 2), y0 + ( nCbS / 2 ), | |
| nCbS / 2,nCbS / 2) | |
| } | |
| pbOffset = ( PartMode = = PART_NxN) ? ( nCbS / 2) | |
| : nCbS | |
| for( j = 0; j < nCbS; j = j + pbOffset ) | |
| for( i = 0; i < nCbS; i = i + pbOffset ) | |
| intra_luma_pred_flag[ x0 + i ][ y0 + j ] | ae(v) |
| } | |
| if( CuPredMode[ x0 ][ y0 ] != MODE_INTRA && | |
| !( PartMode = = PART_2Nx2N && merge_flag[ | |
| x0 ][ y0 ] | |
| ) ) | |
| rqt_root_cbf | ae(v) |
| if( rqt_root_cbf ) { | |
| MaxTrafoDepth = ( CuPredMode[ x0 ] | |
| [ y0 = = MODE_INTRA ? | |
| ( max_transform_hierarchy_depth_intra + | |
| IntraSplitFlag ) : | |
| max_transform_hierarchy_depth_inter ) | |
| transform_tree( x0, y0, x0, y0, log2CbSize, 0, 0 ) | |
| } | |
| } | |
| } | |
| } | |

Referring to Table 5, the parts different from the description for Table 4 and the technical features of the present invention are mainly described. It is noted that the parts of the description omitted below are the same as the description of Table 4.

if(slice_type!=I): In the case that a current coding unit is not a skip mode, a decoder determines whether a type of a current slice is a slice.

pred_mode: In the current slice type is not a slice; the decoder parses ‘pred_mode’.

As described above, the syntax for deriving a prediction mode of the current coding unit may be defined as ‘pred_mode’. Here, in the case that Pred_mode syntax element value is zero, this means it is encoded in an inter-prediction mode. In the case that Pred_mode syntax element value is 10, this means it is encoded in an intra-prediction mode. In the case that Pred_mode syntax element value is 11, this means it is encoded in a Joint inter-intra prediction mode.

else if (CuPredMode[x0][y0]==MODE_INTER): The decoder determines whether a prediction mode of the current coding unit is an inter mode.

In the case that a prediction mode of the current coding unit is not the intra mode, although it is determined to be the inter mode, since a Joint inter-intra prediction mode of the present invention is added, the case of inter mode may be separately limited by using ‘else if’ syntax.

if(PartMode==PART_2N×2N): In the case that a prediction mode of the current coding unit does not correspond to an intra mode and also does not correspond to the inter mode, the decoder determines whether a partition mode (PartMode) of the current coding unit is PART_2N×2N.

Even in the case of the Joint inter-intra prediction mode, in the same way in the inter mode, a decoding process prediction_unit for a prediction unit (or prediction block) are called.

prediction_unit(x0, y0, nCbS, nCbS): In the case that a prediction mode of the current coding unit is the Joint inter-intra prediction mode and a partition mode (PartMode) is PART_2N×2N, a decoding process prediction_unit(x0, y0, nCbS, nCbS) for a prediction unit (or prediction block) are called.

else if(PartMode==PART_2N×N): The decoder determines whether a partition mode (PartMode) of the current coding unit is PART_2N×N.

prediction_unit(x0, y0, nCbS, nCbS/2)

prediction_unit(x0, y0+(nCbS/2), nCbS, nCbS/2): In the case that a prediction mode of the current coding unit is the Joint inter-intra prediction mode and a partition mode (PartMode) is PART_2N×N, a decoding process prediction_unit(x0, y0, nCbS, nCbS/2) and prediction_unit(x0, y0+(nCbS/2), nCbS, nCbS/2) for a prediction unit (or prediction block) are called.

else if(PartMode==PART_N×2N): The decoder determines whether a partition mode (PartMode) of the current coding unit is PART_N×2N.

prediction_unit(x0, y0, nCbS/2, nCbS)

prediction_unit(x0+(nCbS/2), y0, nCbS/2, nCbS): In the case that a prediction mode of the current coding unit is the Joint inter-intra prediction mode and a partition mode (PartMode) is PART_N×2N, a decoding process prediction_unit(x0, y0, nCbS/2, nCbS) and prediction_unit(x0+(nCbS/2), y0, nCbS/2, nCbS) for a prediction unit (or prediction block) are called.

else if(PartMode==PART_2N×nU): The decoder determines whether a partition mode (PartMode) of the current coding unit is PART_2N×nU.

prediction_unit(x0, y0, nCbS, nCbS/4)

prediction_unit(x0, y0+(nCbS/4), nCbS, nCbS*3/4): In the case that a prediction mode of the current coding unit is the Joint inter-intra prediction mode and a partition mode (PartMode) is PART_2N×nU, a decoding process prediction_unit(x0, y0, nCbS, nCbS/4) and prediction_unit(x0, y0+(nCbS/4), nCbS, nCbS*3/4) for a prediction unit (or prediction block) are called.

else if(PartMode==PART_2N×nD): The decoder determines whether a partition mode (PartMode) of the current coding unit is PART_2N×nD.

prediction_unit(x0, y0, nCbS, nCbS*3/4)

prediction_unit(x0, y0+(nCbS*3/4), nCbS, nCbS/4): In the case that a prediction mode of the current coding unit is the Joint inter-intra prediction mode and a partition mode (PartMode) is PART_2N×nD, a decoding process prediction_unit(x0, y0, nCbS, nCbS*3/4) and prediction_unit(x0, y0+(nCbS*3/4), nCbS, nCbS/4) for a prediction unit (or prediction block) are called.

else if(PartMode==PART_nL×2N): The decoder determines whether a partition mode (PartMode) of the current coding unit is PART_nL×2N.

prediction_unit(x0, y0, nCbS/4, nCbS)

prediction_unit(x0+(nCbS/4), y0, nCbS*3/4, nCbS): In the case that a prediction mode of the current coding unit is the Joint inter-intra prediction mode and a partition mode (PartMode) is PART_nL×2N, a decoding process prediction_unit(x0, y0, nCbS/4, nCbS) and prediction_unit(x0+(nCbS/4), y0, nCbS*3/4, nCbS) for a prediction unit (or prediction block) are called.

else if(PartMode==PART_nR×2N): The decoder determines whether a partition mode (PartMode) of the current coding unit is PART_nR×2N.

prediction_unit(x0, y0, nCbS*3/4, nCbS)

prediction_unit(x0+(nCbS*3/4), y0, nCbS/4, nCbS): In the case that a prediction mode of the current coding unit is the Joint inter-intra prediction mode and a partition mode (PartMode) is PART_nL×2N, a decoding process prediction_unit(x0, y0, nCbS*3/4, nCbS) and prediction_unit(x0+(nCbS*3/4), y0, nCbS/4, nCbS) for a prediction unit (or prediction block) are called.

prediction_unit(x0, y0, nCbS/2, nCbS/2)

prediction_unit(x0+(nCbS/2), y0, nCbS/2, nCbS/2)

prediction_unit(x0, y0+(nCbS/2), nCbS/2, nCbS/2)

prediction_unit(x0+(nCbS/2), y0+(nCbS/2), nCbS/2, nCbS/2): In the case that a prediction mode of the current coding unit is the Joint inter-intra prediction mode and a partition mode (PartMode) is PART_N×N, a decoding process prediction_unit(x0, y0, nCbS/2, nCbS/2), prediction_unit(x0+(nCbS/2), y0, nCbS/2, nCbS/2), prediction_unit(x0, y0+(nCbS/2), nCbS/2, nCbS/2) and prediction_unit(x0+(nCbS/2), y0+(nCbS/2), nCbS/2, nCbS/2) for a prediction unit (or prediction block) are called.

pbOffset=(PartMode==PART_N×N) ? (nCbS/2) : nCbS: In the case that a current mode is the Joint inter-intra prediction mode, when the current partition mode (PartMode) is PART_N×N, the pbOffset value is set to nCbS/2, and when the current partition mode (PartMode) is PART_2N×2N, the pbOffset value is set to nCbS,

for(j=0; j<nCbS; j=j+pbOffset)

for(i=0; i<nCbS; i=i+pbOffset)

intra_luma_pred_flag[x0+i][y0+j]: The decoder parses intra_luma_pred_flag[x0+i][y0+j] in a unit of prediction unit.

For example, in the case that a partition mode (PartMode) of the current coding unit is PART_2N×2N, the pbOffset value is set to nCbS. In this case, only intra_luma_pred_flag[x0][y0] is parsed.

In the case that a partition mode (PartMode) of the current coding unit is PART_N×N, the pbOffset value is set to nCbS/2. In this case, intra_luma_pred_flag[x0][y0], intra_luma_pred_flag[x0+nCbS/2][y0], intra_luma_pred_flag[x0][y0+nCbS/2], intra_luma_pred_flag[x0+nCbS/2] y0+nCbS/2] is parsed.

That is, Table 5 is an example of syntax in the case of transmitting the intra-prediction mode, the intra-prediction mode is transmitted in a unit of prediction unit. The decoder parses intra_luma_pred_flag in a unit of prediction unit.

The intra_luma_pred_flag may represent 35 types of intra-prediction modes. In the present disclosure, the intra_luma_pred_flag used as an example of syntax for transmitting an intra-prediction mode, but the method used in the existing intra-prediction mode may be used in the Joint inter-intra prediction mode.

That is, it may be determined whether it is included in the MPM mode by parsing the prev_intra_luma_pred_flag syntax element, and in the case that it is not included in the MPM mode, the intra-prediction mode selected in the encoder among the remaining 32 types by parsing the rem_intra_luma_pred_mode syntax element.

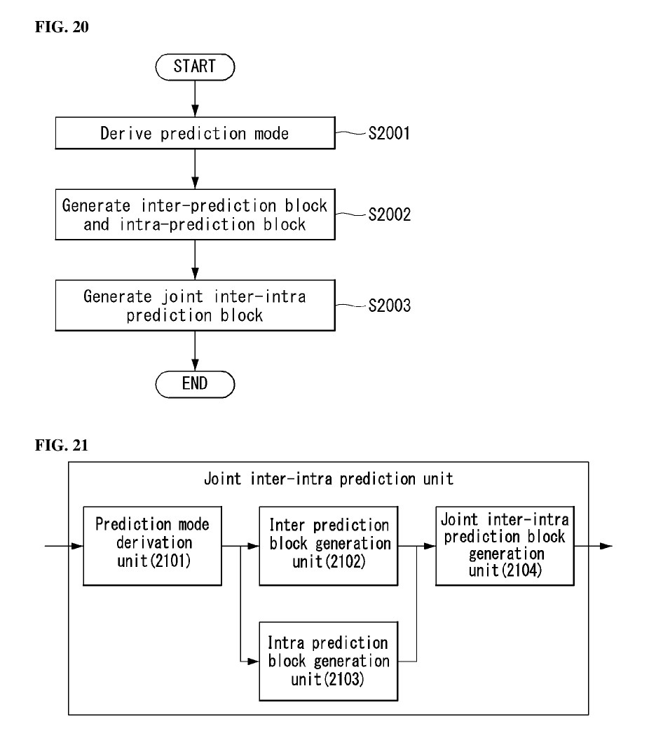

FIG. 20 is a diagram illustrating an image processing method based on a Joint inter-intra prediction mode according to an embodiment of the present invention.

First, a decoder derives a prediction mode of a current block (step, S2001). In the case that the prediction mode of the current block is the Joint inter-intra prediction mode, an inter-prediction block is generated by performing an inter-prediction and an intra-prediction block is generated by performing an intra-prediction (step, S2002).

The decoder may derive motion information for performing the inter-prediction. The decoder may distinguish a reference block within a reference image by using the derived motion information, and may generate an inter-prediction block using the sample value of the reference block (motion compensation).

A method of performing the intra-prediction may be changed according to whether an encoder transmits intra-prediction mode information.

That is, when the intra-prediction mode information is transmitted, the intra-prediction mode is derived from the information transmitted from the encoder first, and an intra-prediction block may be generated by using a reference pixel (left and bottom-left samples, top and top-right samples and a top-left sample) neighboring the current block based on the derived intra-prediction mode.

When the intra-prediction mode information is not transmitted, the intra-prediction may be performed by using a reference pixel (left and bottom-left samples, top and top-right samples and a top-left sample) neighboring the block corresponding to the current block in a reference image. In addition, the decoder may determine the mode that minimizes the Rate-Distortion Cost (RD cost) of the intra-prediction block to be the intra-prediction mode in the same way of the encoder.

Based on the determined intra-prediction mode, an intra-prediction block may be generated by using a reference pixel (left and bottom-left samples, top and top-right samples and a top-left sample) neighboring the block corresponding to the current block in a reference image.

A Joint inter-intra prediction block is generated by combining the inter-prediction block and the intra-prediction block (step, S2003). In this case, the inter-prediction block and the intra-prediction block may be combined by applying weights to each block.

FIG. 21 is a diagram illustrating a Joint inter-intra prediction unit according to an embodiment of the present invention.

Referring to FIG. 21, a Joint inter-intra prediction unit implements functions, procedures and/or methods proposed in FIG. 12 to FIG. 20 above. Particularly, the Joint inter-intra prediction unit may include a prediction mode derivation unit 2101, an inter prediction block generation unit 2102, an intra prediction block generation unit 2103 and a Joint inter-intra prediction block generation unit 2104.

The prediction mode derivation unit 2101 may derive a prediction mode of a current block from the information transmitted from an encoder.

The inter prediction block generation unit 2102 may generate an inter-prediction block of a current process block by performing an inter-prediction.

The inter prediction block generation unit 2102 generates an inter-prediction block by performing the inter-prediction in the method described in FIG. 14. That is, the inter prediction block generation unit 2102 derives motion information (or parameter) from the information transmitted from the encoder, and generates an inter-prediction block by using the derived motion information (or parameter).

Based on the motion information, the motion compensation for generating an inter-prediction block of the current block may be performed as below.

A reference block may be identified in a reference image by using the motion information of the current block, and the inter-prediction sample value of the current block may be generated using the sample value of the current block. In this case, the motion information may include all types of information required for distinguishing a reference block in a reference image.

For example, the motion information may include a reference list (i.e., may indicates L0, L1 or both directions), a reference index (or reference picture index) and motion vector information. That is, a reference image may be selected by using the reference list (i.e., may indicates L0, L1 or both directions) and the reference index (or reference picture index), and the reference block corresponding to the current block may be identified by using the motion vector in the reference image.

In addition, all of the reference list (i.e., may indicates L0, L1 or both directions), the reference index (or reference picture index) and the motion vector information may be transmitted to the decoder, but the merge mode or the AMVP mode may be used for decreasing the traffic in relation to the motion vector information.

For example, in the case that the merge mode is applied to the current block, the decoder may decode a merge index which is signaled from an encoder. Further, the motion information of the current block may be derived from the motion parameter of a candidate block which is indicated in a merge index.

In addition, in the case that the AMVP mode is applied to the current block, the decoder may decode a motion vector difference (MVD), a reference index and an inter-prediction mode that are signaled from the encoder. Further, a motion vector prediction value is derived from a motion parameter of a candidate block indicated from a motion reference flag (i.e., candidate block information), and motion vector information is derived by using a motion vector prediction value and the received motion vector difference (MVD), and accordingly, the motion information of the current block may be derived.

By using the derived motion information, the decoder may identify the reference block in the reference image, and may generate an inter-prediction block of the current block using the sample value of the reference block (motion compensation).

The intra prediction block generation unit 2103 may generate an intra-prediction block by performing the intra-prediction.

The intra prediction block generation unit 2103 may generate an intra-prediction block in different method according to whether intra-prediction mode information is transmitted to the decoder.

That is, when the intra-prediction mode information is transmitted, the intra-prediction mode is derived from the information transmitted from the encoder first, and an intra-prediction block may be generated by using a reference pixel (left and bottom-left samples, top and top-right samples and a top-left sample) neighboring the current block based on the derived intra-prediction mode.

When the intra-prediction mode information is not transmitted, the intra-prediction may be performed by using a reference pixel (left and bottom-left samples, top and top-right samples and a top-left sample) neighboring the block corresponding to the current block in a reference image. In addition, the decoder may determine the mode that minimizes the Rate-Distortion Cost (RD cost) of the intra-prediction block to be the intra-prediction mode in the same way of the encoder.

Based on the determined intra-prediction mode, an intra-prediction block may be generated by using a reference pixel (left and bottom-left samples, top and top-right samples and a top-left sample) neighboring the block corresponding to the current block in a reference image.

The Joint inter-intra prediction block generation unit 2104 generates a Joint inter-intra prediction block by combining the inter-prediction block and the intra-prediction block generated in the inter prediction block generation unit 2102 and the intra prediction block generation unit 2103.

In this case, the inter-prediction block and the intra-prediction block may be combined by applying weights to each block. In addition, the weights applied to the inter-prediction block and the intra-prediction block may be applied in a unit of block or in a unit of pixel.

In addition, weights are applied in a unit of pixel to the inter-prediction block and the intra-prediction block, the weights may be adjusted according to a distance between a reference pixel and a prediction pixel of the current block.

In the aforementioned embodiments, the elements and characteristics of the present invention have been combined in specific forms. Each of the elements or characteristics may be considered to be optional unless otherwise described explicitly. Each of the elements or characteristics may be implemented in such a way as to be not combined with other elements or characteristics. Furthermore, some of the elements and/or the characteristics may be combined to form an embodiment of the present invention. The order of the operations described in connection with the embodiments of the present invention may be changed. Some of the elements or characteristics of an embodiment may be included in another embodiment or may be replaced with corresponding elements or characteristics of another embodiment. It is evident that an embodiment may be configured by combining claims not having an explicit citation relation in the claims or may be included as a new claim by amendments after filing an application.

The embodiment of the present invention may be implemented by various means, for example, hardware, firmware, software or a combination of them. In the case of implementations by hardware, an embodiment of the present invention may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers and/or microprocessors.

In the case of an implementation by firmware or software, an embodiment of the present invention may be implemented in the form of a module, procedure, or function for performing the aforementioned functions or operations. Software code may be stored in memory and driven by a processor. The memory may be located inside or outside the processor, and may exchange data with the processor through a variety of known means.

It is evident to those skilled in the art that the present invention may be materialized in other specific forms without departing from the essential characteristics of the present invention. Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

### INDUSTRIAL APPLICABILITY

The aforementioned preferred embodiments of the present invention have been disclosed for illustrative purposes, and those skilled in the art may improve, change, substitute, or add various other embodiments without departing from the technological spirit and scope of the present invention disclosed in the attached claims.

1. A method for processing an image by combining an inter-prediction and an intra-prediction, the method comprising:
deriving a prediction mode of a current block;
generating an inter-prediction block of the current block and an intra-prediction block of the current block, when the prediction mode of the current block is a Joint inter-intra prediction mode; and
generating a joint inter-intra prediction block by combining the inter-prediction block and the intra-prediction block.

2. The method for processing an image based on a Joint inter-intra prediction mode of claim 1, when intra-prediction mode information of the current block is not transmitted, wherein the intra-prediction block is generated by an intra-prediction by using a reference block neighboring a block corresponding to the current block in a reference picture.

3. The method for processing an image based on a Joint inter-intra prediction mode of claim 2, wherein the intra-prediction mode used in the intra-prediction is determined to be a mode that minimizes a Rate-Distortion Cost of the intra-prediction block.

4. The method for processing an image based on a Joint inter-intra prediction mode of claim 3, wherein the Rate-Distortion Cost is derived from a summation of Distortion and Rate,
wherein a value of the Distortion is calculated by Sum of Square Difference (SSD) of the inter-prediction block and the intra-prediction block, and
wherein a value of the Rate is calculated by considering a bit required to encode residual information that subtracts the intra-prediction block from the inter-prediction block.

5. The method for processing an image based on a Joint inter-intra prediction mode of claim 1, when intra-prediction mode information of the current block is transmitted, wherein the intra-prediction block is generated by an intra-prediction by using the intra-prediction mode.

6. The method for processing an image based on a Joint inter-intra prediction mode of claim 1, wherein the joint inter-intra prediction block is generated by combining the inter-prediction block to which a first weight is applied and the intra-prediction block to which a second weight is applied.

7. The method for processing an image based on a Joint inter-intra prediction mode of claim 6, wherein a ratio of the first weight and the second weight is determined according to a ratio of Sum of Square Difference (SSD) value of the current block and the inter-prediction block to SSD value of the current block and the intra-prediction block.

8. The method for processing an image based on a Joint inter-intra prediction mode of claim 6, wherein the first weight and the second weight are applied in a unit of block or a unit of pixel to the inter-prediction block and the intra-prediction block.

9. The method for processing an image based on a Joint inter-intra prediction mode of claim 8, wherein the second weight decreases and the first weight increases as a distance between a reference pixel used in the intra-prediction and a prediction pixel of the current block increases.

10. The method for processing an image based on a Joint inter-intra prediction mode of claim 8, wherein a ratio of the first weight and the second weight is changed according to a vertical coordinate of a prediction pixel of the current block, when the intra-prediction mode is a vertical mode.

11. The method for processing an image based on a Joint inter-intra prediction mode of claim 8, wherein a ratio of the first weight and the second weight is changed according to a horizontal coordinate of a prediction pixel of the current block, when the intra-prediction mode is a horizontal mode.

12. The method for processing an image based on a Joint inter-intra prediction mode of claim 6, wherein the first weight and the second weight are determined from a weight table which is predetermined according to the inter-prediction mode and/or the intra prediction mode.

13. The method for processing an image based on a Joint inter-intra prediction mode of claim 6, further comprising receiving a table index for specifying the first weight and the second weight,
wherein the first weight and the second weight is determined from a predetermined table by the table index.

14. An apparatus for processing an image by combining an inter-prediction and an intra-prediction, the apparatus comprising:
a prediction mode derivation unit for deriving a prediction mode of a current block;
an inter-prediction block generation unit for generating an inter-prediction block by performing an inter-prediction for the current block;
an intra-prediction block generation unit for generating an intra-prediction block by performing an intra-prediction for the current block; and
a joint inter-intra prediction block generation unit for generating a joint inter-intra prediction block by combining the inter-prediction block and the intra-prediction block.
